(19) United States
(12) Patent Application Publication
(10) Pub. No.: US 2026/0283891 A1
(43) Pub. Date: Sep. 24, 2026

(54) SYSTEM AND METHODS TO IMPROVE ORIENTATION AND MOBILITY OF THE VISUALLY IMPAIRED

(71) Applicant: Arnav CHAPHALKAR, Buffalo Grove, IL (US)

(72) Inventor: Arnav CHAPHALKAR, Buffalo Grove, IL (US)

(21) Appl. No.: 19/084,480

(22) Filed: Mar. 19, 2025

(51) Int. Cl. A61H 3/06

(52) U.S. Cl. CPC A61H 3/061; A61H 3/068; A61H 2201/5048; A61H 2201/5092

(57) ABSTRACT

The present disclosure relates to systems and methods that integrate a cane and mobile phone technology with multi-tier artificial intelligence processing of image data to generate audible guidance and instructions for the visually impaired in a variety of practical environments.

### TECHNICAL FIELD

The present disclosure relates generally to systems, methods, and/or computer-executable instructions for improving and/or assisting the orientation and/or mobility of visually impaired, e.g., blind, or otherwise impaired people.

### BACKGROUND

Visually impaired individuals frequently depend on one or more aids to safely interact with their surroundings. For example, a cane, such as a white cane, can identify obstacles. A service animal can navigate, anticipate objects in motion, find entrances, etc. A human can provide guidance, read signs, etc. However, each of these aids has limitations—a cane cannot anticipate an object in motion, a service animal has a limited ability to interpret a complex environment, and human input may be unavailable. As a result, there is a need for approaches that do not suffer from these limitations to assist the visually impaired.

### BRIEF SUMMARY

An aspect of the present disclosure is based on the discovery of a technique utilizing multiple machine learning models that enables a cane (for example a white cane) or other device to be used in conjunction with a mobile phone to provide audio guidance that enables a visually impaired person to navigate a variety of environments. The presently disclosed systems and methods provide a number of benefits and improvements over prior art solutions. For example, some methods require the user to share an image with a community via a mobile app. The presently disclosed systems and methods are easier and faster to employ. For example, the presently disclosed systems and methods because they can be triggered from a prominent button on a cane rather than a touch screen on a mobile phone, or can even be triggered automatically in some settings without requiring the user's input. Furthermore, the presently disclosed systems and methods generate audio guidance autonomously without the need to consult other individuals. The presently disclosed systems and methods are also more discreet because the user does not have to share their location with unknown persons. Another shortcoming of such prior art solutions is that the guidance tends to be short, perhaps one or two words. In contrast, the methods and systems of the present disclosure provide audio guidance that is demonstrably more descriptive and context-rich.

Certain embodiments may provide, for example, a method (for example a method to assist a visually impaired individual such as a computer-implemented method). In certain embodiments, for example, the method may comprise capturing an image (for example using a smart phone) when prompted by an electromagnetic signal (for example a Bluetooth signal). In certain embodiments, for example, the method may comprise generating a plurality of image captions for the image using a first machine learning model (for example, a convolutional neural network such as a deep learning convolutional neural network). In certain embodiments, for example, the method may comprise further generating a data structure for the plurality of image captions using a second machine learning model (for example, a convolutional neural network or a large language model). In certain embodiments, for example, the data structure may comprise a first subset of image captions of the plurality of image captions. In certain embodiments, for example, the data structure may comprise a second subset of image captions of the plurality of image captions. In certain embodiments, for example, the method may comprise forming a prompt comprising at least a portion of the data structure processing the prompt using a third machine learning model (for example a large language model such as a generalized pretrained transformer model) to obtain a response. In certain embodiments, for example, the method may comprise outputting audio comprising an audio version of at least a portion of the response.

Certain embodiments may provide, for example, a product for providing audio output to assist a visually impaired person. In certain embodiments, for example, the product may comprise a non-transitory computer-readable storage medium having computer-readable program code. In certain embodiments, for example, the computer-readable program code may be executable to perform data processing operations. In certain embodiments, for example, the data processing operations comprise capturing an image when prompted by an electronic signal from a cane (for example a white cane). In certain embodiments, for example, the data processing operation may comprise generating a plurality of image captions for the image using a first machine learning model. In certain embodiments, for example, the data processing operation may comprise further generating a data structure for the plurality of image captions using a second machine learning model. In certain embodiments, for example, the data structure may comprise a first subset of image captions of the plurality of image captions and a second subset of image captions of the plurality of image captions. In certain embodiments, for example, the data processing operation may comprise forming a prompt comprising at least a portion of the data structure. In certain embodiments, for example, the data processing operation may comprise processing the prompt using a third machine learning model to obtain a response. In certain embodiments, for example, the product may comprise outputting audio comprising an audio version of at least a portion of the response.

Certain embodiments may provide, for example, a system for providing audio output to assist a visually impaired person. In certain embodiments, for example, the system may comprise a mobile device configured to capture an image when prompted by an electronic signal from a cane. In certain embodiments, for example, the system may comprise a first machine learning model that receives at least a portion of the image and generates a plurality of image captions for the at least a portion of the image. In certain embodiments, for example, the system may comprise a second machine learning model that generates a data structure for the plurality of image captions. In certain embodiments, for example, the data structure may comprise a first subset of image captions of the plurality of image captions, and a second subset of image captions of the plurality of image captions. In certain embodiments, for example, the system may comprise computer executable instructions that form a prompt comprising at least a portion of the data structure. In certain embodiments, for example, the system may comprise a third machine learning model that processes the prompt to obtain a response. In certain embodiments, for example, the system may comprise an audio output of at least a portion of the response.

In certain embodiments, for example, the signal may be transmitted from a cane (for example by pressing a button on the cane). In certain embodiments, for example, the electro-magnetic signal may be produced by pressing a button. In certain embodiments, for example, the button may be a physical button. In certain embodiments, for example, the button may be a virtual button. In certain embodiments, for example, the button may be attached to (and/or part of and/or integrated into) a cane. In certain embodiments, for example, the button may be attached to (and/or part of an/or integrated into) a wearable wrist device (for example a virtual button). In certain embodiments, for example, the button may be attached to (and/or part of an/or integrated into) a personal mobile cellular device (for example a virtual button). In certain embodiments, for example, the button may be attached to (and/or part of an/or integrated into) a pair of eye-glasses (for example a virtual button).

In certain embodiments, for example, the electrical signal may be triggered by a tactile prompt or a haptic prompt. In certain embodiments, for example, the electromagnetic signal may encode information that is generated by a programmable control circuit. In certain embodiments, for example, the electromagnetic signal may be converted to information that is processed by an application programming interface.

In certain embodiments, for example, the application programming interface may access one or more cameras in an electronic device. In certain embodiments, for example, the application programming interface may access one or more audio outputs (for example one or more speakers) in an electronic device. In certain embodiments, for example, the application programming interface may communicate with (for example make a request to and/or receive information from) a server. In certain embodiments, for example, the server may process the electro-magnetic signal. In certain embodiments, for example, the server may transmit the electromagnetic signal to a client. In certain embodiments, for example, the server may transmit the electro-magnetic signal via a network socket. transmit the electromagnetic signal via a network socket.

In certain embodiments, for example, the client may transmit a signal to the electronic device to capture an image. In certain embodiments, for example, the electromagnetic signal may be transmitted via a wireless connection. In certain embodiments, for example, the wireless connection may be a Bluetooth connection. In certain embodiments, for example, the wireless connection may be a Wi-Fi connection. In certain embodiments, for example, the wireless connection may be a cellular connection. In certain embodiments, for example, the cellular connection may be a connection according to a wireless standard, such as a 2G, 3G, 4G, 5G, or a 6G connection.

In certain embodiments, for example, the image may be captured by at least one electronic device. In certain embodiments, for example, the image may be captured by a camera (for example a digital camera) that is integrated with (or in communication with) a personal mobile device (for example a smart phone). In certain embodiments, for example, the image may be captured by a camera (for example a digital camera) that is integrated with (or in communication with) the cane or other device proximate a visually impaired person. In certain embodiments, for example, the image may be captured by a camera (for example a digital camera) that is integrated with (or in communication with) eyeglasses.

In certain embodiments, for example, the image may be a digital image. In certain embodiments, for example, the digital image may comprise at least a portion of a surrounding environment observed through a view finder of mobile computing device 110. In certain embodiments, for example, the surrounding environment may comprise an indoor environment (for example a home or an office). In certain embodiments, for example, the surrounding environment may comprise an outdoor environment (for example a park, a downtown area, a street, a side-walk, a subway, etc.). In certain embodiments, for example, the surrounding environment may comprise one or more obstacles (for example a fence or a pedestrian) In certain embodiments, for example, the surrounding environment may comprise one or more moving objects (for example a moving vehicle). In certain embodiments, for example, the digital image may be selected from a group consisting of a Red-Green-Blue image, a Cyan-Yellow-Magenta image, or a Hue-Saturation-Value image. In certain embodiments, for example, the image may be a digitally encoded image (for example an MPEG image). In certain embodiments, for example, the image may comprise plural images. In certain embodiments, for example, the plural images may comprise a video. In certain embodiments, for example, the image may be evaluated (for example to determine whether the images meet one or more predetermined tolerances) according to one or more image monitoring criteria (for example, one or more of brightness, contrast, and skew). In certain embodiments, for example, the image may be rejected based on the evaluation and another image is captured. In certain embodiments, for example, the image may be accepted for further processing based on meeting the one or more image monitoring criteria.

In certain embodiments, for example, the image or video may comprise (or be ac-companied by) audio data of the surroundings (inclusive of statements by the visually impaired person). In certain embodiments, for example, the first machine learning model may receive at least a portion of the audio data along with the at least a portion of the image to generate the plurality of image captions for the at least a portion of the image. In certain embodiments, for example, the second machine learning model may receive at least a portion of the audio data along with the plurality of image captions to generate the data structure.

In certain embodiments, for example, the image may be transmitted to a server (for example a cloud server). In certain embodiments, for example, the server may be capable of storing images in memory. In certain embodiments, for example, the server may process the image. In certain embodiments, for example, the processing may comprise generating a plurality of image captions for the image using a first machine learning model. In certain embodiments, for example, the processing may comprise further generating a data structure for the plurality of image captions using a second machine learning model, the data structure comprising a first subset of image captions of the plurality of image captions, a second subset of image captions of the plurality of image captions. In certain embodiments, for example, the processing may comprise forming a prompt comprising at least a portion of the data structure. In certain embodiments, for example, the processing may comprise processing the prompt using a third machine learning model to obtain a response. In certain embodiments, for example, the processing may comprise outputting audio comprising an audio version of at least a portion of the response.

In certain embodiments, for example, the first machine learning model may comprise a convolutional neural network. In certain embodiments, for example, the convolutional neural network architecture may comprise one or more (for example one) of the following architectures: an SPPNet architecture, a D2Det architecture, a RetinaNet architecture, a TridentNet architecture, a CornerNet architecture, a EfficientNet architecture, a CenterNet architecture, and a CentripetalNet architecture. In certain embodiments, for example, the convolutional neural network may utilize a SIFT algorithm, a Media Pipe algorithm, a Pyramid Network architecture, the ImageAI library, an SSD Detection algorithm, or a GluonCV algorithm. In certain embodiments, for example, the convolutional neural network may be a region-based convolutional neural network. In certain embodiments, for example, the region-based convolutional neural network may comprise one or more of a faster region-based neural network, a mask region-based convolutional neural network, and a sparse region-based convolutional neural network.

In certain embodiments, for example, the first machine learning model may comprise at least one layer (for example, one layer, two layers, three layers, four layers, five layers, six layers, seven layers, between eight layers and ten layers, or between eleven layers and twenty layers). In certain embodiments, for example, the first machine learning model may comprise an activation layer. In certain embodiments, for example, the first machine learning model may comprise a pooling layer.

In certain embodiments, for example, the first machine learning model may be trained using a plurality of images (for example images of a location). In certain embodiments, for example, the first machine learning model may detect at least one object within the digital image. In certain embodiments, for example, the first machine learning model may generate a plurality of one-to-two-word captions for the detected at least one object.

In certain embodiments, for example, the second machine learning model may comprise a convolutional neural network. In certain embodiments, for example, the training of the second machine learning model may comprise images annotated with details that are relevant to a visually impaired individual.

In certain embodiments, for example, the second machine learning model may rank the captions. In certain embodiments, for example, the second machine learning model may group the captions generated by the first machine learning model based on similarity and/or a frequency of appearance in the caption list generated by the first machine learning model. In certain embodiments, for example, the second machine learning model may rank a caption by relating the caption to the needs of a visually impaired individual. In certain embodiments, for example, a first caption may be given a higher rank than a second caption based on the first caption having a higher relevance to the orientation and/or mobility of a visually impaired person com-pared to that of the second caption. In certain embodiments, for example, the first caption may describe objects that the visually impaired individual can interact with. In certain embodiments, for example, the first caption may describe a chair, a bench, a sofa, a coffee machine, a handle, an obstacle in the image, a person in the image, a large object, or a combination of two or more of the foregoing. In certain embodiments, for example, the first caption may relate to user safety considerations. In certain embodiments, for example, the first caption may relate to travel time considerations. In certain embodiments, for example, the first caption may relate to colors in the image. In certain embodiments, for example, the first caption may relate to a mood of a person in the image. In certain embodiments, for example, the first caption may relate to a spatial layout of the surrounding environment. In certain embodiments, for example, the first caption may relate to a potential hazard (for example an object that presents a spatial hazard such as a street curb, uneven surface, obstacle at head level, etc.). In certain embodiments, for example, the first caption may relate to information about a person in the image. In certain embodiments, for example, the first caption may relate to text or signage (for example as displayed on a menu, a bus stop, a computer screen, an entrance sign, an exit sign, a street sign, etc.). In certain embodiments, for example, the first caption may relate to a relative distance of objects from the user (for example a distance measured as a number of steps a user must travel to reach an object in the image). In certain embodiments, for example, the first caption may relate to the weather. In certain embodiments, for example, the second caption may relate to an advertisement. In certain embodiments, for example, the second caption may relate to an item of ornamentation. In certain embodiments, for example, the second caption may relate to an object that does not directly relate to the orientation and/or mobility of a visually impaired person. In certain embodiments, for example, the first caption may be included in a caption group while the second caption is not included in a caption group.

In certain embodiments, for example, subsets of the captions may be grouped into a plurality of caption groups. In certain embodiments, for example, a caption group of the plurality of caption groups may contain captions that relate to (for example describe) user safety considerations. In certain embodiments, for example, a caption group of the plurality of caption groups may contain captions that relate to (for example describe) travel time considerations. In certain embodiments, for example, a caption group of the plurality of caption groups may contain captions that relate to (for example describe) colors in the image. In certain embodiments, for example, a caption group of the plurality of caption groups may contain captions that relate to (for example describe) the mood of a person in the image. In certain embodiments, for example, a caption group of the plurality of caption groups may contain captions that relate to (for example describe) spatial layout of the surrounding environment. In certain embodiments, for example, a caption group of the plurality of caption groups may contain captions that relate to (for example describe) the layout of a room. In certain embodiments, for example, a caption group of the plurality of caption groups may contain captions that relate to (for example describe) a seating arrangement. In certain embodiments, for example, a caption group of the plurality of caption groups may contain captions that relate to (for example describe) a general spatial structure. In certain embodiments, for example, a caption group of the plurality of caption groups may describe objects in the image that present potential hazards, such as street curbs, uneven surfaces, obstacles at head level, etc. In certain embodiments, for example, a caption group of the plurality of caption groups may relate to (for example describe) information about the people in the image. In certain embodiments, for example, a caption group of the plurality of caption groups may relate to (for example describe) text in the image such as text displayed on a menu, a bus stop, a computer screen, an entrance sign, an exit sign, or a street sign. In certain embodiments, for example, the prioritized caption group may describe a relative distance of objects from the user. In certain embodiments, for example, the distance may be measured as a number of steps a user must travel to reach an object in the image.

In certain embodiments, for example, the second machine learning model may remove one or more captions (for example remove the one or more captions such as the second caption described above from further utilization by the method or system). In certain embodiments, for example, the second machine learning model may remove one or more captions (for example remove the one or more captions such as the second caption described above because of low relevance to the orientation and/or mobility of a visually impaired person) from inclusion in a caption group. In certain embodiments, for example, the second machine learning model may filter at least 25% of captions generated by the first machine learning model, for example at least 50% of captions generated by the first machine learning model, at least 75% of captions generated by the first machine learning model, or the second machine learning model may filter between 25% and 75% of captions generated by the first machine learning model. In certain embodiments, for example, the removed captions may be redundant. In certain embodiments, for example, the removed captions may be determined to not provide additional useful information to the user according to one or more predetermined criteria. In certain embodiments, for example, the removed captions may describe an object which is determined to not be relevant to the user according to one or more predetermined criteria. In certain embodiments, for example, the removed captions may not describe large or hazardous objects in the location. In certain embodiments, for example, the removed captions may not describe the relative distance of objects in the image relative to the user. In certain embodiments, for example, the removed captions may not describe the signage present within the image. In certain embodiments, for example, the removed captions may not describe the relative distance of objects in the image relative to the user. In certain embodiments, for example, the removed captions may not describe other people present in the image.

In certain embodiments, for example, a first caption group of the plurality of caption groups may be given a higher rank than a second caption group of the plurality of caption groups based on the first caption group having a higher relevance to the orientation and/or mobility of a visually impaired person compared to that of the second caption group. In certain embodiments, for example, the second machine learning model may remove one or more caption groups of the plurality of caption groups (for example remove the one or more captions groups such as the second caption group described above from further utilization by the method or system because of low relevance to the orientation and/or mobility of a visually impaired person).

In certain embodiments, for example, the third machine learning model may be a large language model. In certain embodiments, for example, the large language model may comprise a recurrent neural network. In certain embodiments, for example, the large language model may comprise an attention mechanism. In certain embodiments, for example, the large language model may comprise a hidden Markov Model. In certain embodiments, for example, the large language model may comprise a generative pretrained transformer model.

In certain embodiments, for example, the third machine learning model (for example a large language model) may convert caption groups (for example all caption groups or, alternatively, each caption group that has not been removed due to low relevance to the orientation and/or mobility of a visually impaired person) generated in the second machine learning model to produce sentences. In certain embodiments, for example, a prompt may be provided with the removed captions. In certain embodiments, for example, the prompt may inform the third machine learning model that the removed captions are determined to be irrelevant to the output of the third machine learning model.

In certain embodiments, for example, the prompt may be used in a process for creating sentences. In certain embodiments, for example, the system can additionally incorporate a request from the user to customize the output of the third machine learning model. In certain embodiments, for example, the request may include directions to avoid obstacles. In certain embodiments, for example, the request may provide the location of an object in a location. In certain embodiments, for example, the prompt will include how the input captions were originally generated and grouped. In certain embodiments, for example, the prompt may request the model to generate sentences from these captions. In certain embodiments, for example, the prompt may specify the output is to assist a visually impaired individual. In certain embodiments, for example, the sentences generated by the third machine learning model may be in JSON format. In certain embodiments, for example, the sentences generated by the third machine learning model may be converted into an audio signal.

In certain embodiments, for example, the audio signal may be transmitted to a speaker (for example by a wired connection within a device or by a connection that may comprise a wireless connection). In certain embodiments, for example, the speaker may be attached to the body of the individual. In certain embodiments, for example, the speaker may be an ear-phone. In certain embodiments, for example, the speaker may be physically connected to (or integral with) a personal mobile device. In certain embodiments, for example, the speaker may be physically connected to (or integral with) a pair of eyeglasses. In certain embodiments, for example, the speaker may be physically connected to (or integral with) a device intended to be worn on a wrist.

In certain embodiments, for example, the electromagnetic signal may be produced by a programmable control circuit. In certain embodiments, for example, the electromagnetic signal may be processed by an application programming interface. In certain embodiments, for example, the application programming interface may make a request to a server. In certain embodiments, for example, the application programming interface may access one or more of a camera and a speaker of an electronic device. In certain embodiments, for example, the electronic device may be a mobile cellular phone (for example a smart phone). In certain embodiments, for example, the server (for example a cloud server) may process the electromagnetic signal and transmit the signal wirelessly to a client via a network socket. In certain embodiments, for example, the client may transmit a signal to the phone to capture a digital image.

In certain embodiments, for example, the signal may be transmitted from a device proximate to a visually impaired person. In certain embodiments, for example, the device may be a pedestrian signaling device (for example an electronic pedestrian signal proximate a street crossing. In certain embodiments, for example, the device may be a traffic signaling device. In certain embodiments, for example, the device may be a railroad signaling device (for example, a railroad crossing signaling device). In certain embodiments, for example, the device may be a subway signaling device. In certain embodiments, for example, the device may be a pickup/ drop-off zone signaling device.

Certain embodiments may provide, for example, a method, comprising: capturing an image when prompted by an electromagnetic signal from a cane (or other device proximate a visually impaired person; generating a plurality of image captions for the image using a first machine learning model; further generating a data structure for the plurality of image captions using a second machine learning model, the data structure comprising a first subset of image captions of the plurality of image captions, a second subset of image captions of the plurality of image captions; forming a prompt comprising at least a portion of the data structure processing the prompt using a third machine learning model to obtain a response; and outputting audio comprising an audio version of at least a portion of the response.

Certain embodiments may provide, for example, as system, the system comprising: a cane configured to transmit an electromagnetic signal in response to a tactile input from a user; a downloadable app embodied in a first non-transitory computer-readable storage medium, the downloadable app comprising first computer-readable program code, the first computer-readable program code executable on a mobile computing device to perform communication management operations, the communication management operations comprising: capturing a digital image in response to the electromagnetic signal; transmitting the digital image via a wireless network; receiving a text description of the digital image via the wireless network; and playing an audio version of the text description; and an application programming interface embodied in a second non-transitory computer-readable storage medium, the application programming interface comprising second computer-readable program code, the second computer-readable program code executable on the mobile computing device to perform data processing operations, the data processing operations comprising: obtaining a plurality of image captions for the digital image from a first machine learning model; further obtaining a data structure from a second machine learning model, the data structure comprising a first subset of image captions of the plurality of image captions, and a second subset of image captions of the plurality of image captions; forming a prompt comprising the data structure; and submitting the prompt to a third machine learning model to obtain the text description of the digital image.

Certain embodiments may comprise, for example, a method, the method comprising: transmitting an electromagnetic signal from a cane in response to a tactile input from a user; capturing a digital image in response to the electromagnetic signal; transmitting the digital image via a wireless network; obtaining a plurality of image captions for the digital image from a first machine learning model; further obtaining a data structure from a second machine learning model, the data structure comprising a first subset of image captions of the plurality of image captions, and a second subset of image captions of the plurality of image captions; forming a prompt comprising the data structure; submitting the prompt to a third machine learning model to obtain the text description of the digital image; receiving a text description of the digital image via the wireless network; and playing an audio version of the text description.

Certain embodiments may provide, for example, a system, the system comprising: a cane configured to transmit an electromagnetic signal in response to a tactile input from a user; a downloadable app embodied in a non-transitory computer-readable storage medium, the downloadable app comprising computer-readable program code, the computer-readable program code executable on a mobile computing device to perform operations comprising: capturing a digital image in response to the electromagnetic signal; transmitting the digital image via a wireless network to at least one server; receiving a text description of the digital image via the wireless network from the at least one server; and playing an audio version of the text description; the at least one server configured to execute operations comprising: generating a plurality of image captions for the digital image from a first machine learning model; generating a data structure from a second machine learning model, the data structure comprising one or more subsets of image captions of the plurality of image captions; and submitting a prompt comprising the data structure to a third machine learning model to obtain the text description of the digital image.

In certain embodiments, for example, the mobile device may be a smartphone. In certain embodiments, for example, the first machine learning model may be a convolutional neural network. In certain embodiments, for example, the second machine learning model may be a large language model. In certain embodiments, for example, the third deep learning model may be a generative pretrained transformer with attention. In certain embodiments, for example, the plurality of image captions may comprise between 50 and 200 image captions. In certain embodiments, for example, a first subset of image captions of the one or more subsets of image captions may comprise image captions that characterize a mood of the digital image. In certain embodiments, for example, a first subset of image captions of the one or more subsets of image captions may comprise image captions that characterize a spatial layout in the digital image. In certain embodiments, for example, a first subset of image captions of the one or more subsets of image captions may comprise image captions that characterize obstacles in the digital image. In certain embodiments, for example, a first subset of image captions of the one or more subsets of image captions may comprise image captions that characterize hazards in the digital image. In certain embodiments, for example, a first subset of image captions of the one or more subsets of image captions may comprise image captions that characterize a spatial layout in the digital image. In certain embodiments, for example, a first subset of image captions of the one or more subsets of image captions may comprise image captions that characterize text in the digital image. In certain embodiments, for example, a first subset of image captions of the one or more subsets of image captions may comprise image captions that characterize an advertisement in the digital image. In certain embodiments, for example, the prompt may comprise a request from a user of the system. In certain embodiments, for example, the prompt may comprises description of the one or more subsets of image captions. In certain embodiments, for example, the second machine learning model may remove a portion of the plurality of captions so that the portion is not present in the first subset of image captions and the portion is not present in the second sub-set of image captions. In certain embodiments, for example, the prompt may comprise an explanation that the removed portion was removed due to lack of relevance to the output of the third machine learning model. In certain embodiments, for example, the cane may be a white cane. In certain embodiments, for example, the operations executable on a mobile computing device may further comprise: recording an audio signal initiated by the user; generating the request based on the recorded audio signal; and transmitting the request to the at least one server.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 depicts a simplified schematic view of an exemplary method for providing information to a visually impaired person, according to certain embodiments of the present disclosure.

FIG. 2 depicts a simplified schematic depiction of an exemplary cane and button assembly, according to certain embodiments of the present disclosure.

FIG. 3 depicts a simplified circuit for transmitting a signal, according to certain embodiments of the present disclosure.

FIG. 4 depicts a simplified schematic depiction of an exemplary process using an artificial neural network-based system, according to certain embodiments of the present disclosure.

FIG. 5 depicts a first exemplary image in accordance with an embodiment of the present disclosure.

FIG. 6 depicts exemplary captions for the first exemplary image in accordance with an embodiment of the present disclosure.

FIG. 7 depicts exemplary groupings of captions for the first exemplary image in accordance with an embodiment of the present disclosure.

FIG. 8 depicts an exemplary prompt associated with the first exemplary image in accordance with an embodiment of the present disclosure.

FIG. 9 depicts an exemplary output associated with the first exemplary image in accordance with an embodiment of the present disclosure.

FIG. 10 depicts a second exemplary image in accordance with an embodiment of the present disclosure.

FIG. 11 depicts exemplary captions for the second exemplary image in accordance with an embodiment of the present disclosure.

FIG. 12 depicts exemplary groupings of captions for the second exemplary image in accordance with an embodiment of the present disclosure.

FIG. 13 depicts exemplary output associated with the second exemplary image in accordance with an embodiment of the present disclosure.

FIG. 14 depicts a third exemplary image in accordance with an embodiment of the present disclosure.

FIG. 15 depicts exemplary captions for third exemplary image in accordance with an embodiment of the present disclosure.

FIG. 16 depicts exemplary groupings of captions third exemplary image in accordance with an embodiment of the present disclosure.

FIG. 17 depicts exemplary output associated with the third exemplary image in accordance with an embodiment of the present disclosure.

FIG. 18 depicts a fourth exemplary image in accordance with an embodiment of the present disclosure.

FIG. 19 depicts exemplary captions for the fourth exemplary image in accordance with an embodiment of the present disclosure.

FIG. 20 depicts exemplary groupings of captions for the fourth exemplary image in accordance with an embodiment of the present disclosure.

FIG. 21 depicts exemplary output associated with the fourth exemplary image in accordance with an embodiment of the present disclosure.

FIG. 22 depicts a fifth exemplary image in accordance with an embodiment of the present disclosure.

FIG. 23 depicts exemplary captions for the fourth exemplary image in accordance with an embodiment of the present disclosure.

FIG. 24 depicts exemplary groupings of captions for the fourth exemplary image in accordance with an embodiment of the present disclosure.

FIG. 25 depicts exemplary output associated with the fourth exemplary image in FIG. 24 in accordance with an embodiment of the present disclosure.

FIG. 26 depicts fifth exemplary image in accordance with an embodiment of the present disclosure.

FIG. 27 depicts exemplary captions for the fifth exemplary image in accordance with an embodiment of the present disclosure.

FIG. 28 depicts exemplary groupings of for the fifth exemplary image in accordance with an embodiment of the present disclosure.

FIG. 29 depicts exemplary output associated with the fifth exemplary image in accordance with an embodiment of the present disclosure.

FIG. 30 depicts a sixth exemplary image in accordance with an embodiment of the present disclosure.

FIG. 31 depicts exemplary captions for the sixth exemplary image in accordance with an embodiment of the present disclosure.

FIG. 32 depicts exemplary groupings of captions for the sixth exemplary image in accordance with an embodiment of the present disclosure.

FIG. 33 depicts exemplary output associated with the sixth exemplary image in accordance with an embodiment of the present disclosure.

### DETAILED DESCRIPTION

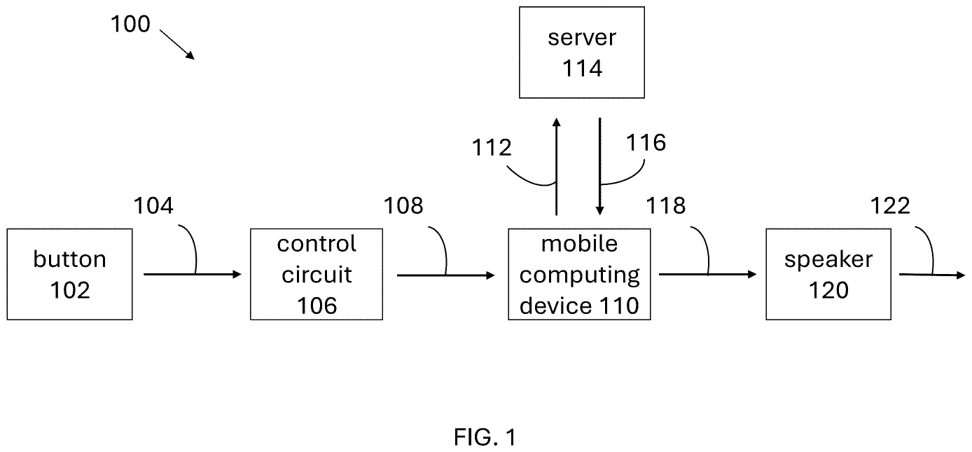

FIG. 1 shows an exemplary method 100 for providing information relating to a surrounding environment to a user, such as a visually impaired user. The method utilizes components of a system that includes button 102, control circuit 106, mobile computing device 110, server 114, and/or speaker 120. Speaker 120 may be part of or separate from mobile computing device 110. The exemplary method 100 includes steps 104, 108, 112, 116, and/or 118.

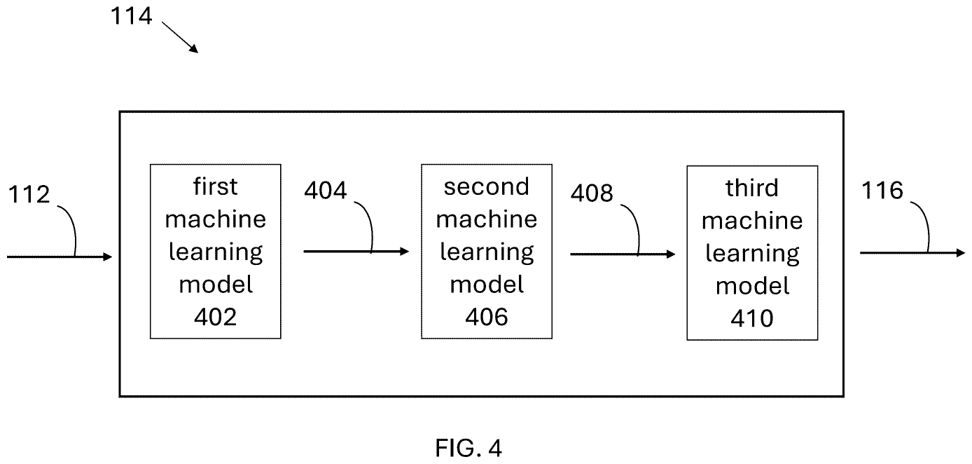

In step 104, button 102 (for example a button on a cane or other device) is pressed causing control circuit 106 to generate an electromagnetic signal. Button 102 can be a mechanical button, a flip switch, a touch screen button, etc. In some embodiments, button 102 may be manually enabled by the user by, for example, pressing, touching, or depressing the button. In step 108, the electromagnetic signal is transmitted to mobile computing device 110 (for example by a Bluetooth, WiFi, or cellular connection) which signals mobile computing device 110 to capture an image (for example using a digital camera to capture a digital image). In step 112, mobile computing device 110 transmits the captured image to server 114, and the image is processed at server 114 using one or more computer-implemented machine learning models to generate one or more sentences (for example, a paragraph) describing the image. An embodiment of three computer-implemented machine learning models is depicted in FIG. 4. The sentences generated in step 116 preferably contain information of interest to the visually impaired user including, for example, information to assist their orientation and mobility.

Mobile computing device 110 transmits the image to server 114 via one or more networks or combinations of networks including one or more of a wireless network (such as a Wi-Fi, cellular, a hotspot, and/or satellite network), a local area network, a wide area network, an intranet, the public Internet, etc. In some embodiments, image and other data may be contained in an Internet Protocol packet (for example an IPv4 or an IPv6 packet) and sent via user datagram protocol (UDP) or transmission control protocol (TCP). In TCP, a connection may be established between mobile computing device 110 and server 114. In certain embodiments, for example, a TCP connection may be secure. For example, a TCP connection may be secured according to a protocol such as socket secured layer (SSL), transport layer security (TLS), Internet Protocol security (IPSec), by a virtual private network (VPN) connection between mobile computing device 110 and server 114, or other protocol.

In step 116, the generated one or more sentences are transmitted from server 114 via the one or more networks back to mobile computing device 110. In step 118, the one or more sentences are converted to audio data and transmitted to speaker 120. In step 122, speaker 120 output the audio data. In some embodiments, as an alternative to steps 112 and 116 involving server 114, mobile computing device 110 may process the image captured by mobile computing device 110 to generate the one or more sentences, using one or more machine learning models on the mobile computing device 110, such as one or more deep learning models. In some embodiments, part of the image processing to generate the one or more sentences occurs on server 114 and part occurs on mobile computing device 110.

Mobile computing device 110 may be a portable device including a microprocessor, memory, display, touchscreen, camera, speakers, and/or microphone. Mobile computing device 110 may be capable of wireless communication, such as by having WiFi, near-field communication, Bluetooth, and/or cellular functionality, such as by including a WiFi, Bluetooth, and/or cellular processor, transceiver, and/or antenna, for communicating with server 114 and/or cane (or other device responsible for transmitting the electromagnetic signal to mobile computing device 110). For example, a Bluetooth enabled system transmits and receives data wirelessly over short distances using radio waves in the 2.4 GHz ISM spectrum band (2400 to 2483.5 MHz). A WiFi enabled system transmits and receives wirelessly via an access point using radio waves in several frequency ranges, including 2.4 GHz, 5 GHz, and 6 GHz.

In certain embodiments, for example, mobile computing device 110 can be a mobile cellular device such as a smartphone. Use of a mobile cellular device may provide a number of advantages over other mobile computing devices 110. For example, many visually impaired individuals have camera phones or smartphones. A mobile cellular device is also configured to connect to a data network to receive and transmit data wirelessly (for example to and from a cane, nearby computing device, and/or a remote server) via a cellular network, Bluetooth, and/or WiFi. In alternative embodiments, mobile computing device 110 may be a tablet, a laptop computer, a handheld computer, a personal digital assistant, a mobile internet device, a personal navigation device, a smartwatch, smart glasses or other suitable head-mounted display. Mobile computing device 110 may have a camera or may be configured to be connected to a handheld or otherwise mobile or portable camera.

Data transmitted or received by mobile computing device 110 in step 112 can include data for an image, such as pixel data or a bitstream representing a compressed version of pixel data. Image data can also include metadata, such as information specifying the device, owner, time, date, tags, and/or location data for the image. Data can also include captions, prompts, and/or sentences. Data can also include position and velocity information obtained from mobile computing device 110, such as from a Global Positioning System (GPS) system on mobile computing device 110. Position information can be related to a map such with information such as a map that includes street map, mass transit locations, access locations for elevators and escalators, business establishments, and so on. Velocity information can be related to a mode of transportation (for example walking or driving), for example. The mobile computing device 110 can also capture audio from the user or from the surrounding environment, for example via a microphone of mobile computing device 110. Audio input from the user can include, for example, a question regarding navigation, safety concerns, or a comment about the surroundings. Audio from the surroundings can include, for example, sounds indicative of a moving object such as a car or train, wind, water, and so on. Such audio input can be converted to descriptive text data and provided with image data to server 114 in step 112. Other data can be provided by mobile computing device 110 with image data to server 114 in step 112, such as device orientation.

In some embodiments, mobile computing device 110 can host application software (for example, a full application or a thin client) to capture an image, process the image, and send the relevant outputs to a connected earphone. The application software may be available to mobile computing device 110 as a downloadable app. The software application can be configured to, among other functions, process the electromagnetic signal (step 108), capture an image, transmit the image (step 112), receive the sentences describing the image (step 116), and convert the sentences to an audio format and play the audio (step 118). In certain embodiments, each of these steps can be performed wholly by the software application running on mobile computing device 110, or the software application may interface with other software running on mobile computing device 110 to perform one or more of these tasks through an application programming interface (API). In other embodiments, the API can interface with a remote website to perform one or more of steps 104, 108, 112, 116, 118, and 122.

Server 114 can include computing hardware in a network or cloud and configured to run one or more machine learning models. Such a server includes more or more graphics processing units (GPUs) such as between one and sixteen GPUs with high throughput memory such as 80 or more gigabytes (GBytes) of memory per GPU and high bandwidth interconnects (for example an NVLink interconnect) between GPUs. Exemplary GPUs include Nvidia H100 and GB200 GPUs. Memory can include high bandwidth memory standard 3 (HBM3).

Speaker 120 can be an earphone worn by the user. The earphone may, for example, be a headphone, earpiece, earbud, hearing aid, or other device. The earphone may be connected to an external device, such as mobile computing device 110, via a wired connection or wirelessly, such as via Bluetooth or using near field communication. Alternatively, speaker 120 may be a speaker in mobile computing device 110, such as a speaker of a smartphone.

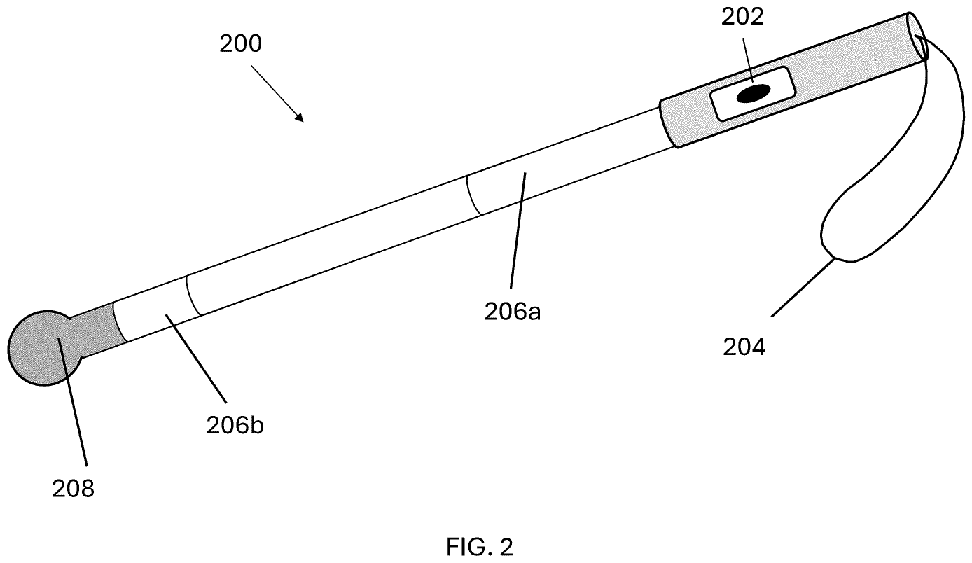

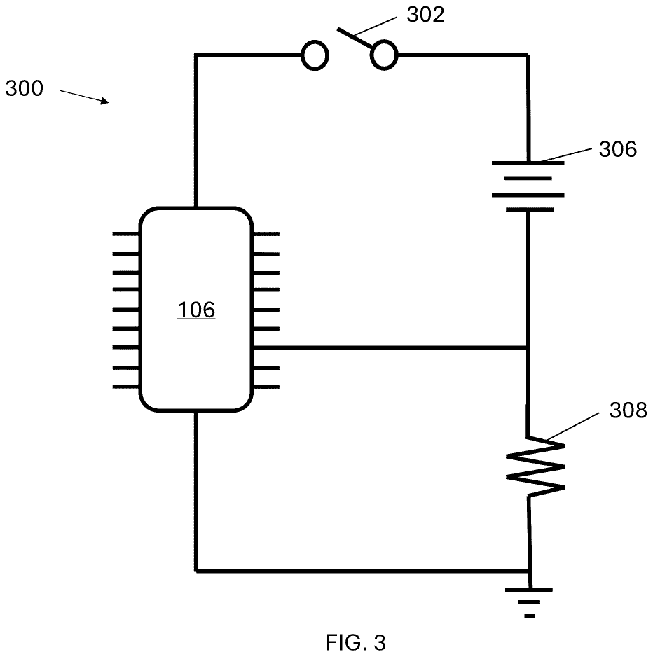

FIG. 2 depicts cane 200 with button assembly 202 and wrist strap 204. Cane 200 may be, for example, a white cane, which is a cane configured for use by a visually impaired user to help navigate the user's environment. In some embodiments, cane 200 has telescoping re-tractable elements 206a and 206b that enable the cane to be retracted for storage. The bottom of the cane may have tip 208. Button assembly 202 can be located near the top of cane 200 so as to be closer to where cane 200 is held by the user. Button assembly 202 may contain electronics to transmit an electromagnetic signal to mobile computing device 110. For example, button assembly 202 may include button 102 and control circuit 106. More generally, button assembly 202 can include circuit 300 of FIG. 3. Button assembly 202 can be battery powered.

FIG. 3 depicts an exemplary circuit 300 that causes control circuit 106 to generate an electromagnetic signal when switch 302 is closed. Circuit 300 includes switch 302, control circuit 106, battery 306, and resistor 308. Switch 102 may, for example, be opened and closed by the user contacting button 102. In some embodiments, switch 302 can be opened and closed by voice activation (for example by the user's instruction). When switch 302 is closed, a signal is sent to control circuit 106, which triggers control circuit 106 to send the electromagnetic signal in step 108. In certain embodiments, for example, control circuit 106 may comprise an EPS 32 Arduino microcontroller. The electromagnetic signal sent by control circuit 106 may be sent wirelessly (e.g., via Bluetooth) and may signal mobile computing device 110 to capture an image. Battery 306 provides power to circuit 300. An exemplary battery is a 300 mAH battery pack. Resistor 308 can be a pull-down resistor that is connected to control circuit 106 to ensure that the circuit is grounded correctly when button 102 is in the open position. For example, resistor 308 may connect to the ground pin of an EPS 32 Arduino control circuit. In certain embodiments, for example, control circuit 160 is an EPS 32 Arduino control circuit. Circuit 300 can be protected by a casing.

FIG. 4 depicts computer-implemented models on server 114 including first machine learning model 402, second machine learning model 406, and third machine learning model 410. First machine learning model 402 generates one or more short captions describing the image received by server 114 in step 112. Second machine learning model 406 groups the captions generated by the first machine learning model based on similarity and/or a frequency of appearance in the caption list generated by the first machine learning model. In certain embodiments, for example, the second machine learning model may rank a caption by relating the caption to the needs of a visually impaired individual. Third machine learning model 410 generates a description of the image based on a portion of the grouped captions, corresponding to the description re-turned by server 114 to mobile computing device 110 in step 116.

As described in greater detail below, each machine learning models may comprise an artificial neural network. The artificial neural network may be a deep learning model, i.e., an artificial neural network having multiple layers of interconnected nodes that can be trained with large data sets to learn complex patterns. Suitable types of deep learning artificial neural networks include a convolutional neural network (CNN) and a large language model (LLM).

An artificial neural network model contains parameters that determine the output of the model for a given input. To form a model that will make useful predictions, the parameters in the model must be calibrated using “training data” that includes pairs of inputs and desired outputs. In the calibration process, weights and biases in the artificial neural network model are iteratively adjusted to minimizing a loss function to improve the model's predictive accuracy. Loss functions and methods of minimization are known to a person of ordinary skill in the art. For example, a commonly used loss function is the average of the squared error of predictions, or other regression metric. A commonly used method of minimization is the conjugant gradient method.

Referring again to first machine learning model 402, a caption can identify and/or describe objects in an image, placement of the objects, and context regarding the image, including mood, light, and other contextual details. Object descriptions can include text such as verbiage on a street sign. In certain embodiments, for example, the caption may describe objects that the visually impaired individual can interact with. In certain embodiments, for example, the caption may describe a chair, a bench, a sofa, a coffee machine, a handle, an obstacle in the image, a person in the image, a large object, or a combination of two or more of the foregoing. Non-limiting examples of captions include captions that relate to (for example describe) user safety considerations; captions that relate to (for example describe) travel time considerations; captions that relate to (for example identify) colors in the image; captions that relate to (for example describe) the mood of a person in the image; captions that relate to (for example describe) spatial layout of the surrounding environment; captions that relate to (for example describe) layout of a room; captions that relate to (for example describe) a seating arrangement; captions that relate to (for example describe) a general spatial structure; captions that describe objects in the image that present potential hazards, such as street curbs, uneven surfaces, obstacles at head level, etc; captions that relate to (for example describe) information about one or more persons in the image such as an identify based on facial recognition; captions that describe (for example summarize or recite) text in the image such as text displayed on a menu, a bus stop, a computer screen, an entrance sign, an exit sign, or a street sign; captions that describe a relative distance of objects from the user, such as a number of steps a user must travel to reach an object in the image.

A caption can be just one word, or may comprise a plurality of words (for example, 1 word, 2 words, 3 words, 4-6 words, 6-10 words, etc.). The number of captions can be just one caption or may comprise a plurality of captions (for example, 1 caption, 2 captions, 3 captions, in the range of between 4 captions and 6 captions, in the range of between 6 captions and 10 captions, more than 10 captions, etc.). In certain embodiments, for example, the number of captions may be in the range of between 5 captions and 500 captions, for example in the range of between 10 captions and 250 captions, in the range of between 25 captions and 250 captions, or the number of captions may be in the range of between 50 and 200 captions.

In addition to the image, in some embodiments input to the first machine learning model 402 includes image-related data such as image metadata, including information specifying the device, owner, time, date, tags, and/or location data for the image. Input can also include position and velocity information, as well as audio input from the user or from the surroundings, via mobile computing device 110.

In some embodiments, first machine learning model 402 includes a CNN. A CNN can have at least three types of layers, including a convolutional layer, a pooling layer, and a fully-connected layer. See IBM, “What are convolutional neural networks,” available at https://www.ibm.com/think/topics/convolutional-neural-networks. Each convolutional layer includes one or more feature detectors which scan the image for course features. The feature detector is a two-dimensional (2-D) array of weights applied to each block of image data resulting in a feature map for the image. In one or more pooling layers, the feature map is simplified to produce an output with a reduced number of parameters. In the fully-connected layer, output from the pooling layer is classified based on features extracted in the convolutional and pooling layers. The CNN can perform optical character recognition to construct captions that include text from the image, such as street signage. Using the layers described above, the CNN preprocesses the image to detect a coarse location of text. Next, text patterns are bounded by a bounding box and the contents associated with text in one or more layers of the CNN. The text is converted into machine-readable format for further processing. In some embodiments, first machine learning model 402 can generate captions based on facial recognition. As a non-limiting example, U.S. Pat. No. 10,915,788, incorporated herein by reference in its entirety, describes suitable techniques for using a CNN to perform optical character recognition. In some embodiments, the facial recognition data can be stored and associated with a caption for the name of an individual. As a non-limiting example, U.S. Pat. No. 10,025,950, incorporated herein by reference in its entirety, describes suitable techniques for using a CNN to perform facial recognition. In some embodiments, the stored data can be used to recognize individuals in an image who have been previously identified.

A person of ordinary skill in the art is aware of suitable CNNs for implementation of the first machine learning model 402, including LeNet-5, AlexNet, VGGNet, GoogLeNet, ResNet, ZFNet, SPPNet, D2Det, RetinaNet, TridentNet, CornerNet, EfficientNet, CenterNet or CentripetalNet. In certain embodiments, for example, the convolutional neural network may utilize a SIFT algorithm, a Media Pipe algorithm, a Pyramid Network architecture, the ImageAI library, an SSD Detection algorithm, or a GluonCV algorithm.

In certain embodiments, for example, first machine learning model 402 may be trained using a standard set of images with corresponding labels, such as MNIST, CIFAR-10, and/or ImageNet. The CIFAR-10 dataset, for example, a widely used computer vision dataset consisting of 60,000 32×32 color images, divided into 10 classes (airplane, automobile, bird, cat, deer, dog, frog, horse, ship, truck), with 6,000 images per class, commonly used for training machine learning algorithms. In other embodiments, for example, the first machine learning model 402 may be further trained using a dataset of images and labels selected to be representative of the environments encountered by a visually impaired person. Such a data set can be generally applicable to the needs of the visually impaired, or it may be customized to an individual. For example, a customized dataset might include labeled images of streets, transit centers, building interiors, etc. routinely encountered by a particular individual.

In some embodiments, for example, first machine learning model 402 can be a Recognize Anything Model (RAM), such as an optimized (for example optimized or hyper-optimized) open-source RAM captioning model. A RAM model can extract visual features from an image and the features against learned patterns to generate captions. An optimized or hyper-optimized RAM model may be trained and filtering parameters adjusted to detect a greater number of captions than a RAM model that has not been hyper-optimized.

In step 404, the captions generated by first machine learning model 402 are transferred to second machine learning model 406 (for example a second deep learning model such as a large language model). Second machine learning model 406 processes the captions by, for example, organizing, grouping, prioritizing, selecting, removing, and/or filtering the captions to identify relevant or important captions and/or remove irrelevant or redundant captions.

Second machine learning model 406 can be a convolutional neural network (CNN), a large language model (LLM), or other type of machine learning model. In some embodiments, for example, the second machine learning model 406 may comprise a CNN including a deep learning classifier configured to filter irrelevant captions and/or output relevant captions.

Second machine learning model 406 can filter the captions based on predetermined criteria. Suitable predetermined criteria can be ascertained by conducting one or more surveys to determine what information visually impaired individual prioritize regarding a location. Second machine learning model 406 can be trained based, in part, on said predetermined criteria. Alternatively, the captions can be augmented with the survey results as input to the second machine learning model 406. Predetermined criteria can include identification of items that the user can interact with (chairs, benches, sofas, etc.); spatial layout of a location; hazards or obstacles in a location that would affect the users movement (e.g. curbs, uneven surfaces, obstacles at head level); information about the proximity of others in relation to the user; text and signage (menus, bus stops, displays, entrance/exit signs); and distance information detailing the relative position of objects to the user. At least 25% of captions can be filtered out based on such predetermined criteria (for example, at least 50% or at least 75%) such that the filtered-out captions are not present in output of the second machine learning model 406. Second machine learning model 406 can group the remaining captions as further described herein. Grouped captions can include (but are not limited to) groups of physical categories (e.g. items, vehicles, signs); mood or lighting of the image; and colors.

In step 408, remaining caption(s) identified by second machine learning model 406 are transferred to third machine learning model 410 (for example a third deep learning model such as a large language model, which can be the same or different from the second deep learning model). In some embodiments, the captions identified by second machine learning model 406 form at least part of a prompt for third machine learning model 410. Third machine learning model 410 may group relevant captions together and uses these groups to generate sentences describing contents of the image. In some embodiments, the generated sentences may be conveyed by mobile computing device 110 of FIG. 1 as audio to a user via speaker 120 of FIG. 1.

Third machine learning model 410 can be an LLM or other type of machine learning model. In some embodiments, the prompt provides information about input captions and/or caption groups and can explain that the captions were generated by first machine learning model 402. The prompt can explain that the captions were then filtered and grouped based on relevance to a visually impaired individual. The prompt can also instruct the third machine learning model 410 to group similar captions or caption groups together and to generate sentences from these groups. In some embodiments, the prompt may be preset by server 114. In some embodiments, the prompt may be customized by an input (such as an audio input) from the user that has been converted to machine readable text (for example by first machine learning model 402). In some embodiments, the customized prompt can instruct third machine learning model 410 to generate sentences from only those captions which describe at least one aspect of the image. In some embodiments, the customized prompt can instruct third machine learning model 410 to prioritize the description of hazards or obstacles in the image.

The prompt can also instruct on the format of the output, including that the third machine learning model 410 should keep the generated sentence concise without losing information from the grouped captions. The third machine learning model 410 can generate sentences. The sentences can describe objects in the image associated with the filtered set of captions. The sentences can also describe signage in the image associated with the filtered captions and/or provide possible uses of objects in the image which are represented by the filtered captions.

Non-limiting examples of an LLM employed for the second machine learning model 406 or the third machine learning model 410 include a recurrent neural network, an LLM with an attention mechanism, hidden Markov model, a generative pretrained transformer model, and a combination of two or more of the foregoing. An LLM can be implemented as a deep learning model that can be built according to a transformer architecture and trained on very large data sets to perform natural language processing tasks. The underlying transformer architecture is a set of artificial neural networks that consist of an encoder and a decoder with self-attention capabilities. In a transformer model, self-attention refers to a mechanism that allows the model to focus on different parts of an input sequence when processing each element, essentially “paying attention” to the relationships between different words within the sequence, by calculating how important each word is to the current word being processed, enabling it to better understand context and long-range dependencies within the data. See Vaswani et al, “Attention Is All You Need” (2017). The encoder and decoder extract meanings from a sequence of text and understand the relationships between words and phrases in it. Transformer LLMs can be implemented as very large models, often with hundreds of billions of parameters that ingest massive amounts of data such as the content of the public internet. A person of ordinary skill in the art is aware of suitable LLMs for implementation of the second and/or third machine learning models. A non-exclusive list of pre-trained LLMs which can be utilized in accordance with the present disclosure include Gpt-3, Gpt-3.5, Gpt-4, Gpt-4o, Cohere, Falcon, DeepSeek-R1, Ernie, Gemini, Gemma, Granite, Llama, Mistral, o1, o3, Phi, Qwen, StableLM, Tülu 3, Claude, Claude 3, Palm, Lamda, and Vicuna-33b.

### Examples

### Example 1

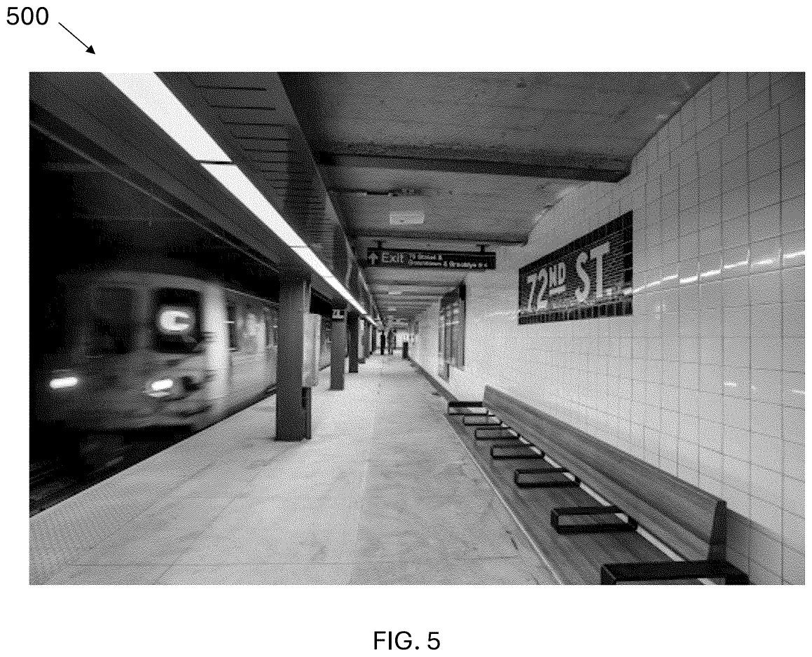

A non-limiting example of using system 100 and cane 200 is provided in FIGS. 5-9 and the accompanying description below. In accordance with step 104, image 500 (shown in FIG. 5) is captured by pressing button 102. In accordance with step 108, control circuit 106 sends a signal to phone 110. Phone 110 then captures image 500. In this example, image 500 shows a train moving in a subway station. In step 112, phone 110 sends image 500 to server 114. Image 500 is then processed using process 400 (FIG. 4).

Image 500 can be captured using software on mobile computing device 110 (for example a Smartphone app). For example, a smartphone can utilize an application program interface (Javascript Camera API and the Web Speech API) to access a camera on the mobile computing device 110.

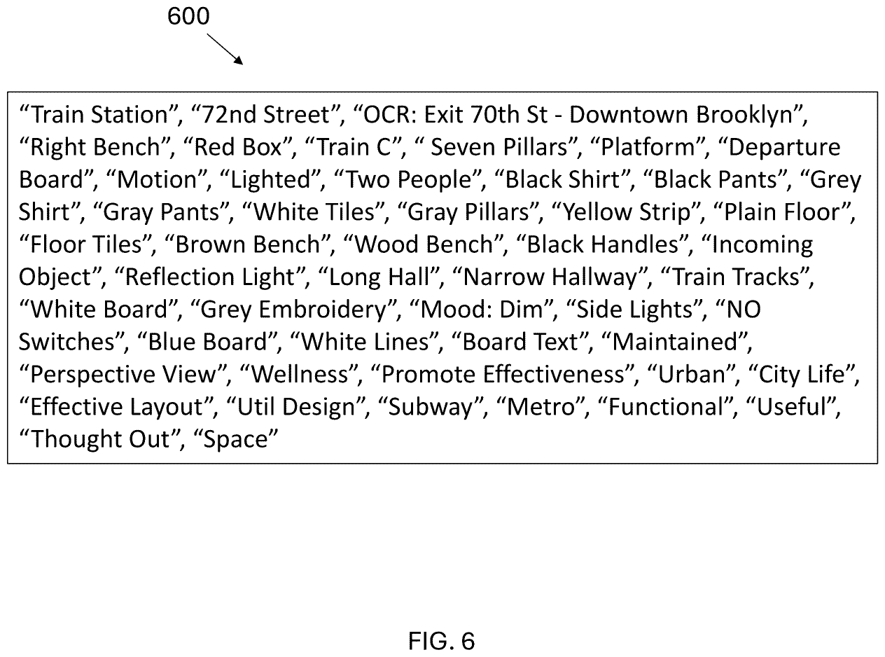

FIG. 6 depicts exemplary captions 600 generated by first machine learning model 402 for exemplary image 500. The captions 600 contain data about the context of the image to inform the generated sentences. In particular, the captions describe objects in the image as well as other characteristics, like the mood, light, and other contextual details. In this example, first machine learning model 402 is implemented using a hyper-optimized open-source version of the Recognize Anything Model, or RAM (https://recognize-anything.github.io/). The filtering parameters of machine learning model 402 were optimized to generate more captions compared to the base RAM model. The number of captions 600 is selected to provide sufficient information for further processing. In step 404, captions 600 are then sent to second layer 406.

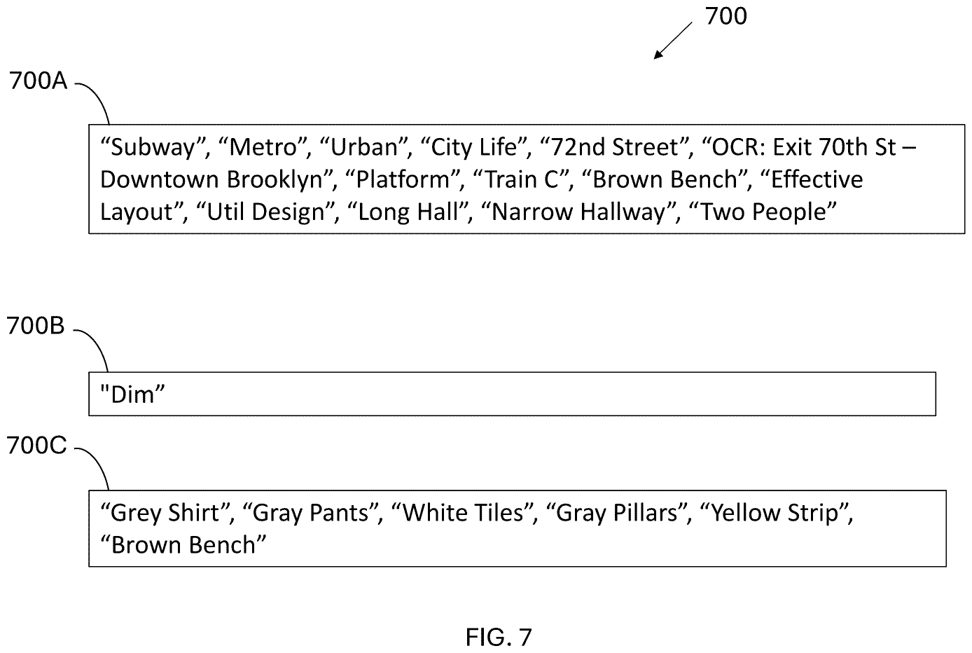

FIG. 7 depicts groupings of captions 700A-C obtained by processing captions 600 using second machine learning model 406. The first group of captions 700A relates to the context of image 500. The second group of captions 700B (which is 1 caption) relates to the mood conveyed by image 500. The third group of captions 700C relates to objects in image 500.

The second machine learning model 406 is trained to filter a subset of captions 600 such that the remaining captions include features which are potentially important to a visually impaired individual, such as features of the train station and lighting conditions relevant to safety. In accordance with step 408, filtered captions 700A-C are then sent to third machine learning model 410.

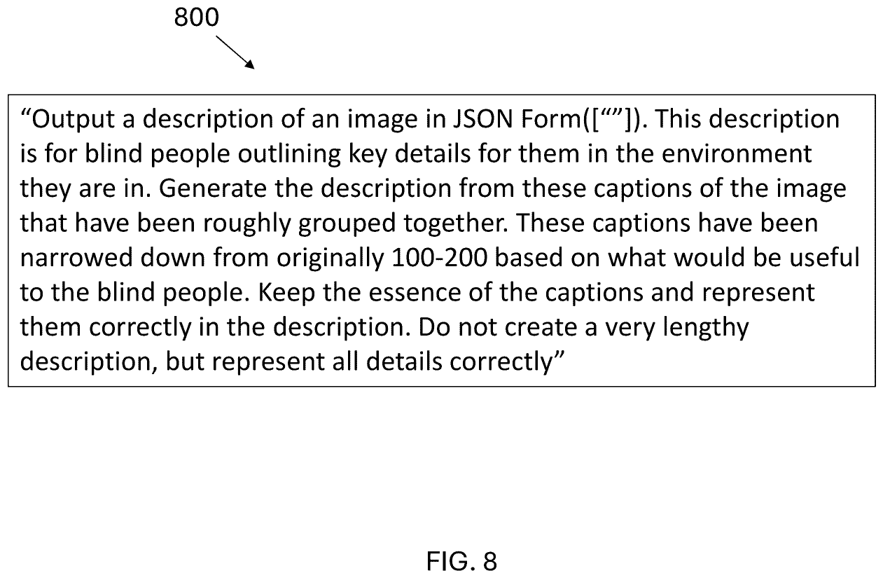

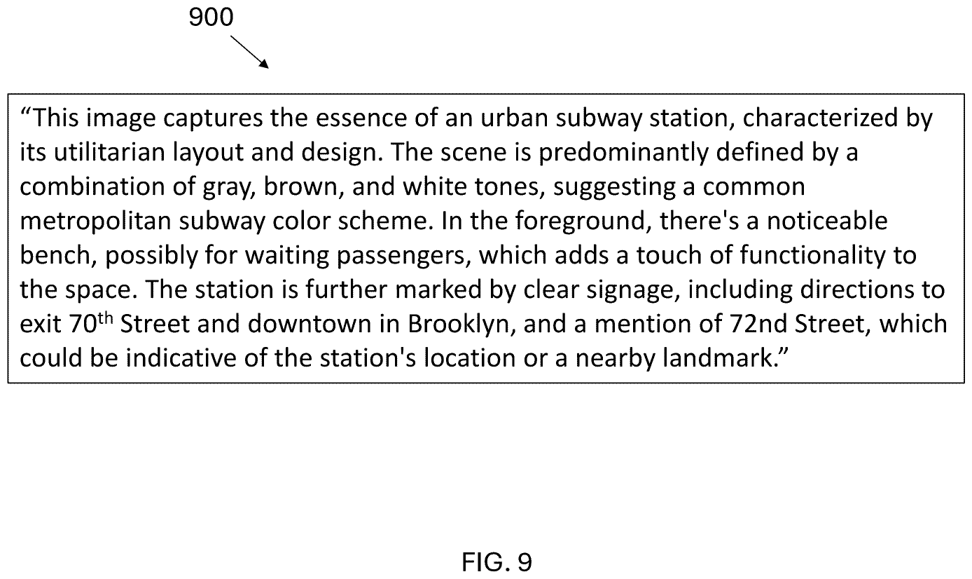

FIG. 8 depicts an exemplary prompt 800 submitted to third machine learning model 410. In the third machine learning model 410, sentences 900 (see FIG. 9 and description below) are formed from the filtered captions. The third machine learning model 410 is a standard large language model from Astica (https://www.astica.org/gpt-s/). In addition, prompt 800 is sent to third neural network-based artificial intelligence model 410.

In accordance with step 116, sentences 900 are then sent from server 114 to phone 110. FIG. 9 depicts sentences 900 describing image 500 produced by third neural network model 410 in response to prompt 800.

### Example 2

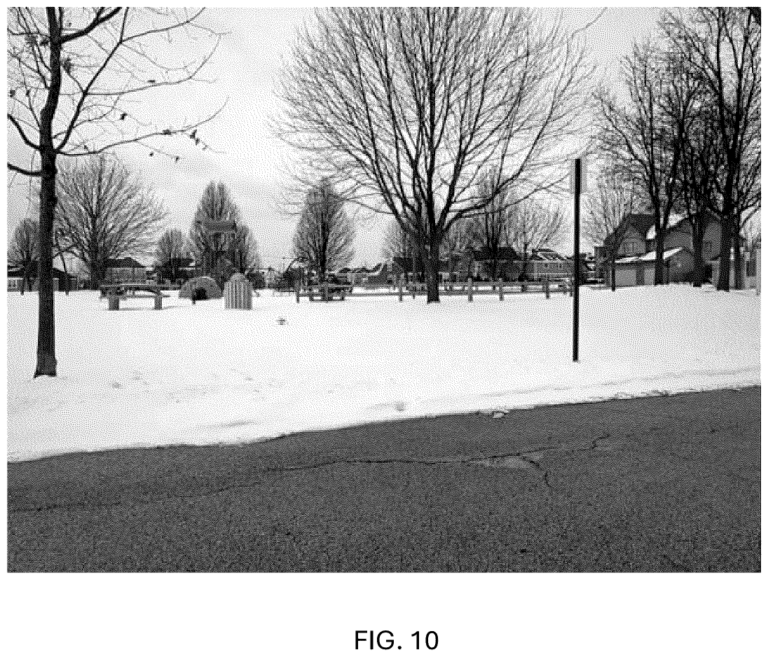

A non-limiting example of using system 100 and cane 200 is provided in FIGS. 10-13 and the accompanying description below. In accordance with step 104, image 1000 (shown in FIG. 10) is captured by pressing button 102. In accordance with step 108, control circuit 106 sends a signal to phone 110. Phone 110 then captures image 1000. In this example, image 1000 shows a playground covered in snow. In step 112, phone 110 sends image 1000 to server 114. Image 1000 is then processed using process 400 (FIG. 4).

Image 1000 can be captured using software on mobile computing device 110 (for example a Smartphone app). For example, a smartphone can utilize an application program interface (Javascript Camera API and the Web Speech API) to access a camera on the mobile computing device 110.

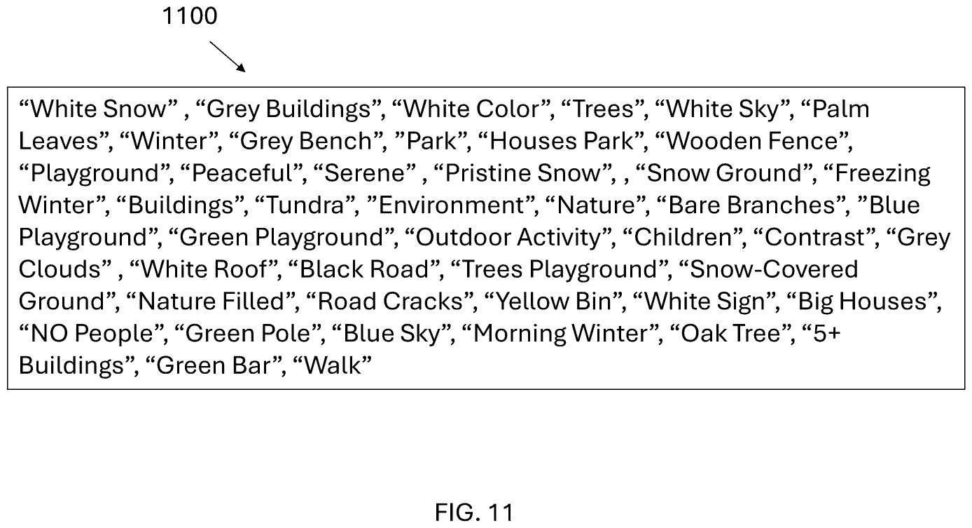

FIG. 11 depicts exemplary captions 1100 generated by first machine learning model 402 for exemplary image 1000. The captions 1100 contain data about the context of the image to inform the generated sentences. In particular, the captions describe objects in the image as well as other characteristics, like the mood, light, and other contextual details. In this example, first machine learning model 402 is implemented using a hyper-optimized open-source version of the Recognize Anything Model, or RAM (https://recognize-anything.github.io/). The filtering parameters of machine learning model 402 were optimized to generate more captions compared to the base RAM model. The number of captions 1100 is selected to provide sufficient information for further processing. In step 404, captions 1100 are then sent to second layer 406.

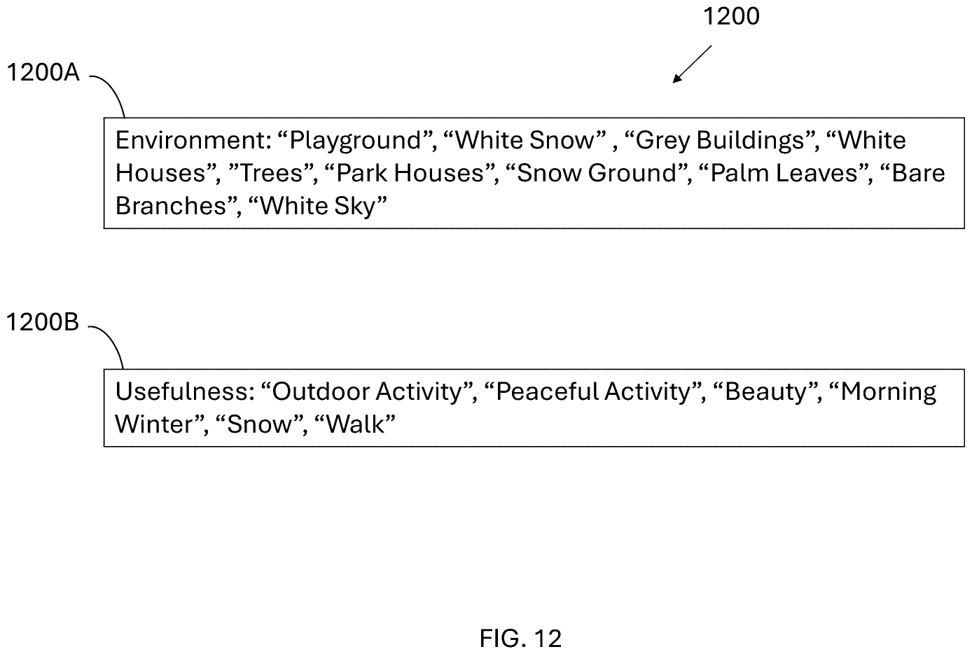

FIG. 12 depicts groupings of captions 1200A-B obtained by processing captions 1100 using the second machine learning model 406. The first group of captions 1200A relates to the environment of image 1000 and describes various objects in the image such as the playground and surrounding trees. The second group of captions 1200B relates to the mood conveyed by image 1000.

The second machine learning model 406 is trained to filter a subset of captions 1100 such that the remaining captions include features which are potentially important to a visually impaired individual, such as features of the playground and large objects that are potential obstacles. In accordance with step 408, filtered captions 1200A-B are then sent to third machine learning model 410.

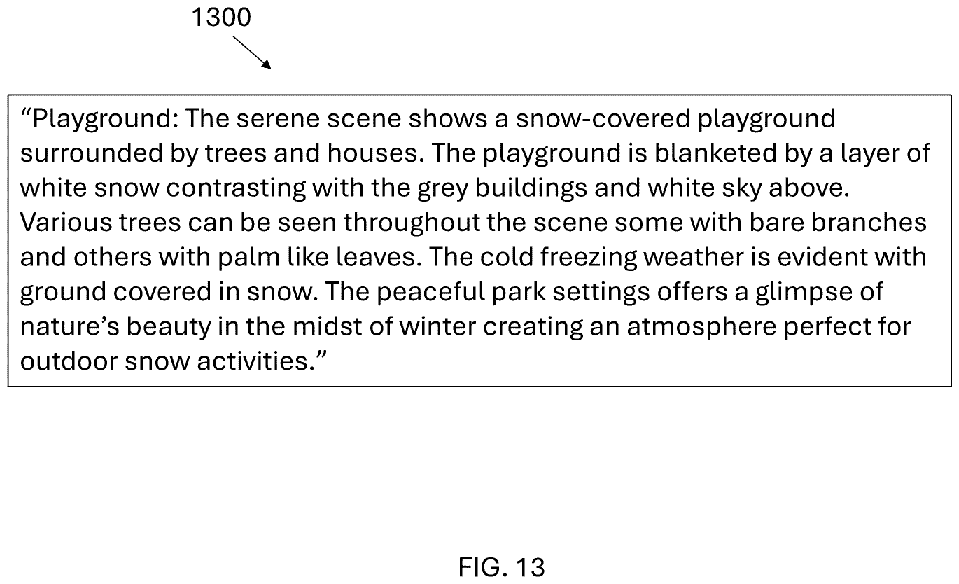

In the third machine learning model 410, sentences 1300 (see FIG. 13 and description below) are formed from the filtered captions. The third machine learning model 410 is a standard large language model from Astica (https://www.astica.org/gpt-s/). In addition, prompt 800 is sent to third machine learning model 410.

In accordance with step 116, sentences 1300 are then sent from server 114 to phone 110. FIG. 13 depicts sentences 1300 describing image 1000 produced by third machine learning model 410 in response to prompt 800.

### Example 3

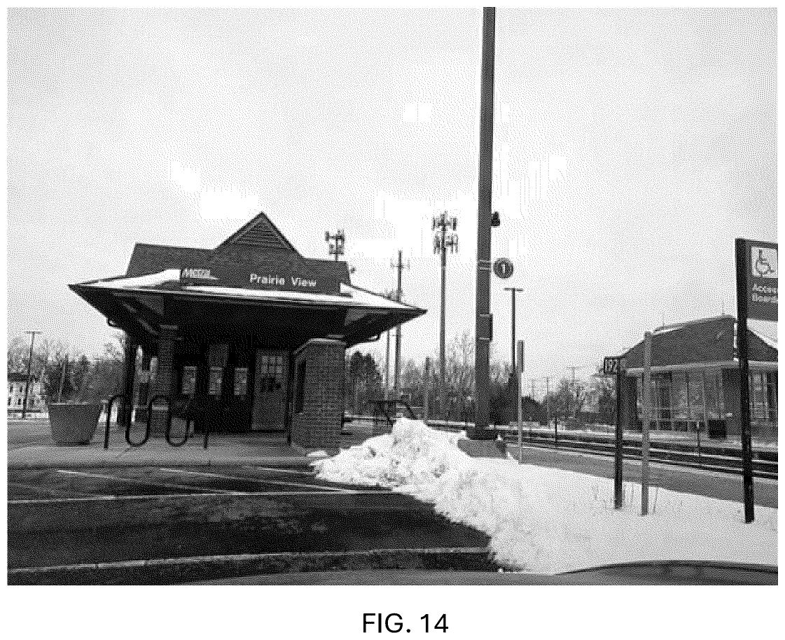

A non-limiting example of using system 100 and cane 200 is provided in FIGS. 14-17 and the accompanying description below. In accordance with step 104, image 1400 (shown in FIG. 14) is captured by pressing button 102. In accordance with step 108, control circuit 106 sends a signal to phone 110. Phone 110 then captures image 500. In this example, image 1000 shows a train station. In step 112, phone 110 sends image 1400 to server 114. Image 1400 is then processed using process 400 (FIG. 4).

Image 1400 can be captured using software on mobile computing device 110 (for example a Smartphone app). For example, a smartphone can utilize an application program interface (Javascript Camera API and the Web Speech API) to access a camera on the mobile computing device 110.

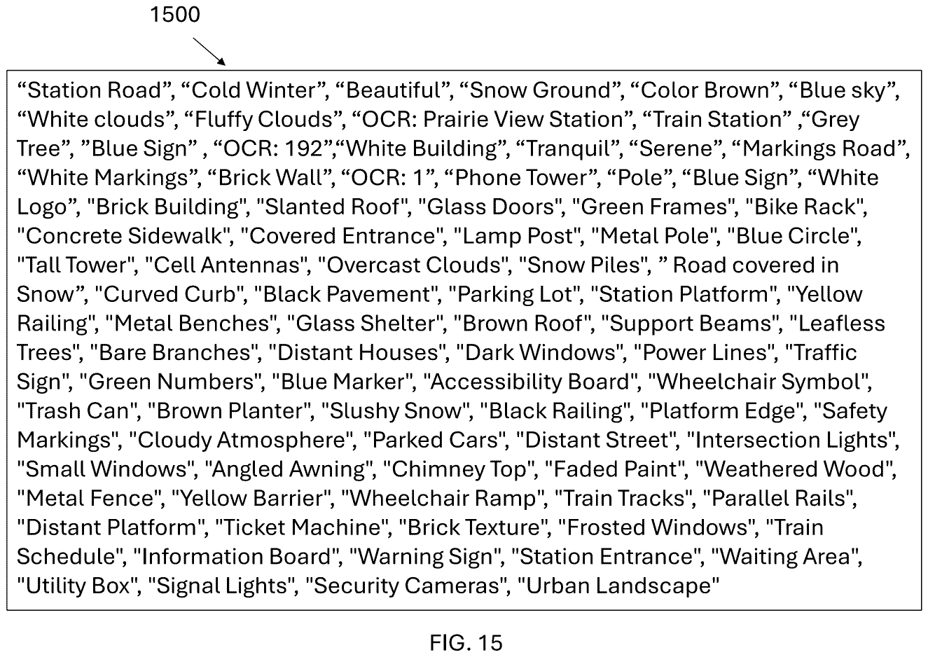

FIG. 15 depicts exemplary captions 1500 generated by first machine learning model 402 for exemplary image 1400. The captions 1500 contain data about the context of the image to inform the generated sentences. In particular, the captions describe objects in the image as well as other characteristics, like the mood, light, and other contextual details. In this example, first machine learning model 402 is implemented using a hyper-optimized open-source version of the Recognize Anything Model, or RAM (https://recognize-anything.github.io/). The filtering parameters of machine learning model 402 were optimized to generate more captions compared to the base RAM model. The number of captions 1500 is selected to provide sufficient information for further processing. In step 404, captions 1500 are then sent to second layer 406.

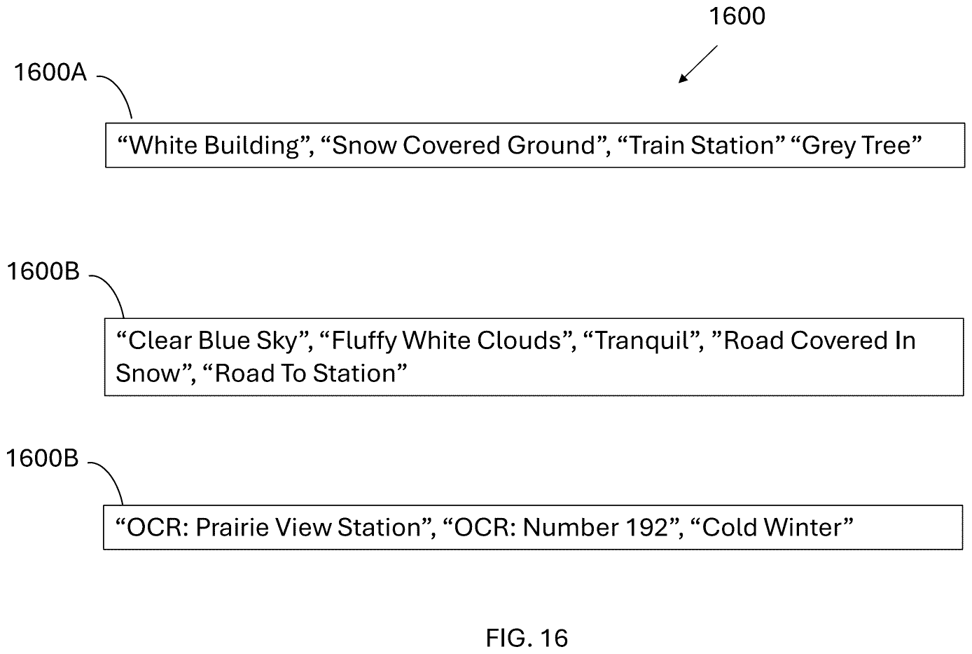

FIG. 16 depicts groupings of captions 1600A-C obtained by processing captions 600 using the second machine learning model 406. The first group of captions 1600A describes various objects in the image such as buildings and surrounding trees. The second group of captions 1600B relates to the environment of the image including the weather and surrounding roads. The third group of captions 1600C shows text detected in the image.

The second machine learning model 406 is trained to filter a subset of captions 1500 such that the remaining captions include features which are potentially important to a visually impaired individual, such as features of the train station and surrounding environment. In accordance with step 408, filtered captions 1600A-C are then sent to third machine learning model 410.

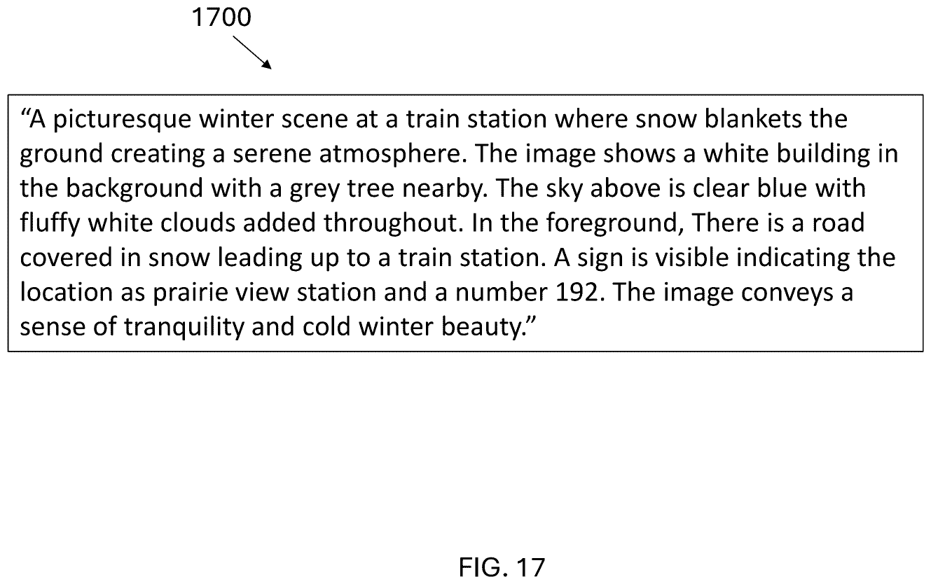

In the third machine learning model 410, sentences 1700 (see FIG. 17 and description below) are formed from the filtered captions. The third machine learning model 410 is a standard large language model from Astica (https://www.astica.org/gpt-s/). In addition, prompt 800 is sent to third machine learning model 410.

In accordance with step 116, sentences 1700 are then sent from server 114 to phone 110. FIG. 17 depicts sentences 1700 describing image 1400 produced by third machine learning model 410 in response to prompt 800.

### Example 4

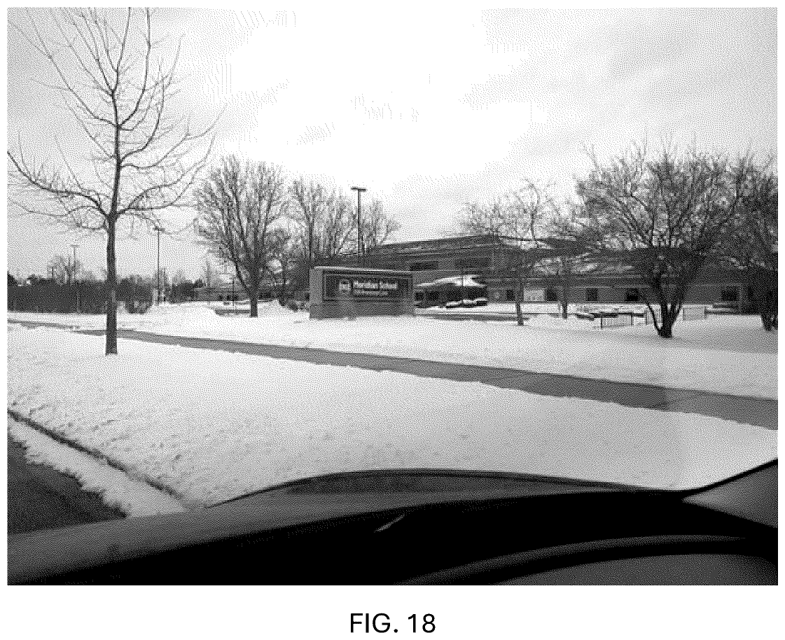

A non-limiting example of using system 100 and cane 200 is provided in FIGS. 18-21 and the accompanying description below. In accordance with step 104, image 1800 (shown in FIG. 18) is captured by pressing button 102. In accordance with step 108, control circuit 106 sends a signal to phone 110. Phone 110 then captures image 1800. In this example, image 1800 shows a school covered in snow. In step 112, phone 110 sends image 1800 to server 114. Image 1800 is then processed using process 400 (FIG. 4).

Image 1800 can be captured using software on mobile computing device 110 (for example a Smartphone app). For example, a smartphone can utilize an application program interface (Javascript Camera API and the Web Speech API) to access a camera on the mobile computing device 110.

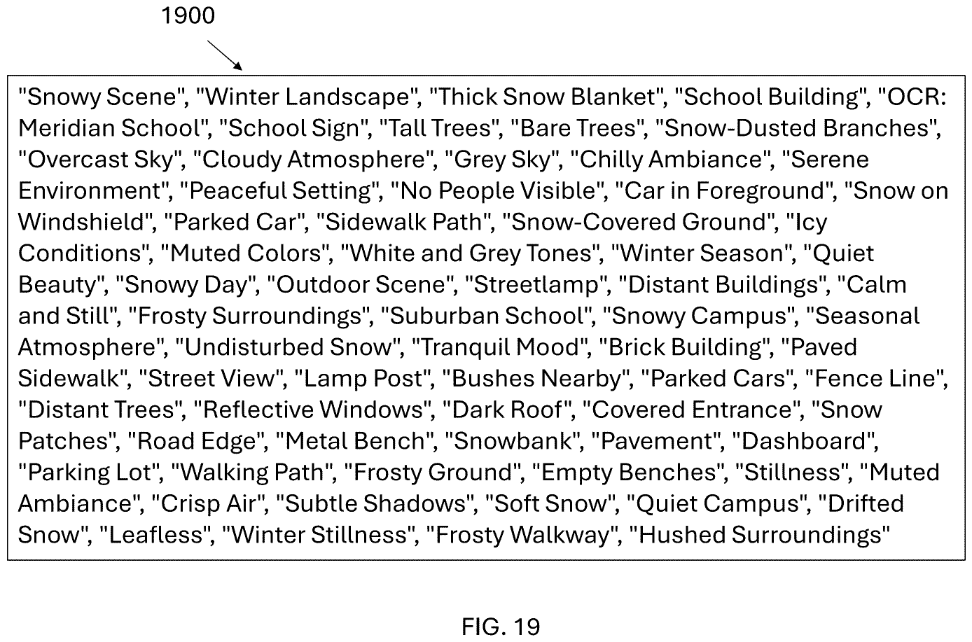

FIG. 19 depicts exemplary captions 1900 generated by first machine learning model 402 for exemplary image 1800. The captions 1500 contain data about the context of the image to inform the generated sentences. In particular, the captions describe objects in the image as well as other characteristics, like the mood, light, and other contextual details. In this example, first machine learning model 402 is implemented using a hyper-optimized open-source version of the Recognize Anything Model, or RAM (https://recognize-anything.github.io/). The filtering parameters of machine learning model 402 were optimized to generate more captions compared to the base RAM model. The number of captions 1900 is selected to provide sufficient information for further processing. In step 404, captions 1900 are then sent to second layer 406.

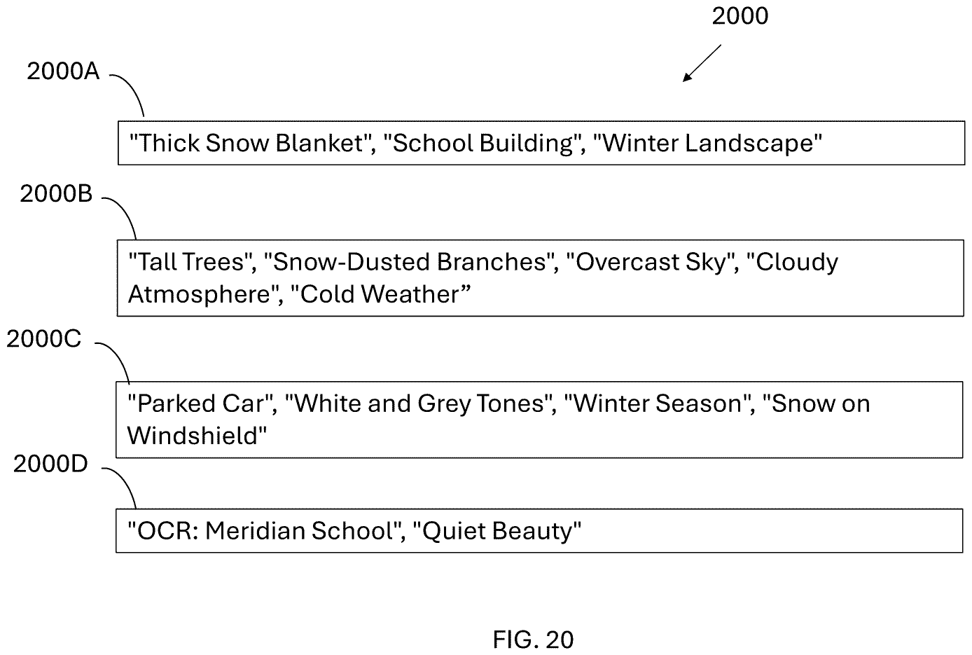

FIG. 20 depicts groupings of captions 2000A-D obtained by processing captions 1900 using the second machine learning model 406. The first group of captions 2000A describes various objects in the image. The second group of captions 2000B relates to the environment of the image including the surrounding trees and weather. The third group of captions 2000C indicates that the picture is taken inside a parked car and describes aspects of the car captured in the image. The fourth caption group 2000D produces text detected in the image.

The second machine learning model 406 is trained to filter a subset of captions 1900 such that the remaining captions include features which are potentially important to a visually impaired individual, such as features of the school and surrounding environment. In accordance with step 408, filtered captions 2000A-C are then sent to third machine learning model 410.

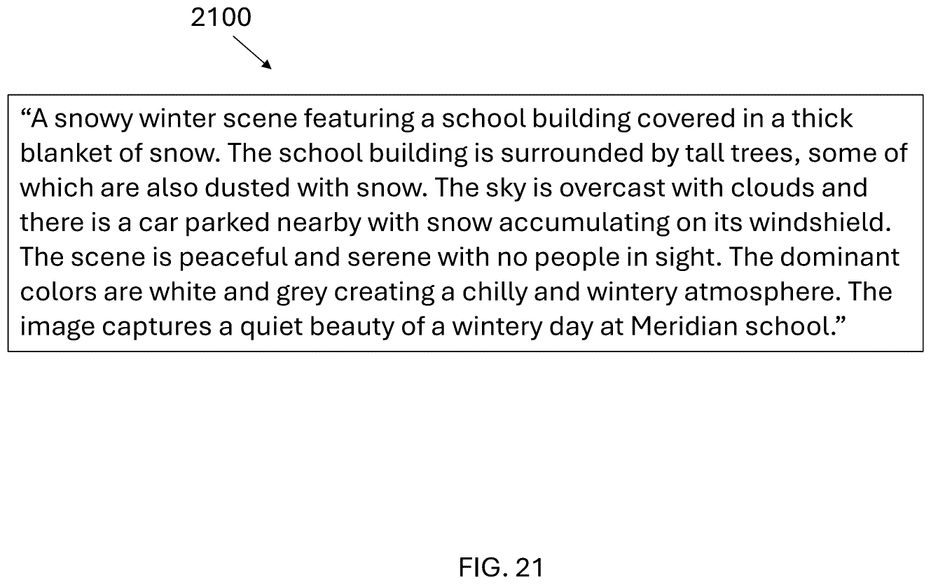

In the third machine learning model 410, sentences 2100 (see FIG. 21 and description below) are formed from the filtered captions. The third neural network-based artificial intelligence model 410 is a standard large language model from Astica (https://www.astica.org/gpt-s/). In addition, prompt 800 is sent to third neural network-based artificial intelligence model 410.

In accordance with step 116, sentences 2100 are then sent from server 114 to phone 110. FIG. 18 depicts sentences 2100 describing image 1800 produced by third neural network model 410 in response to prompt 800.

### Example 5

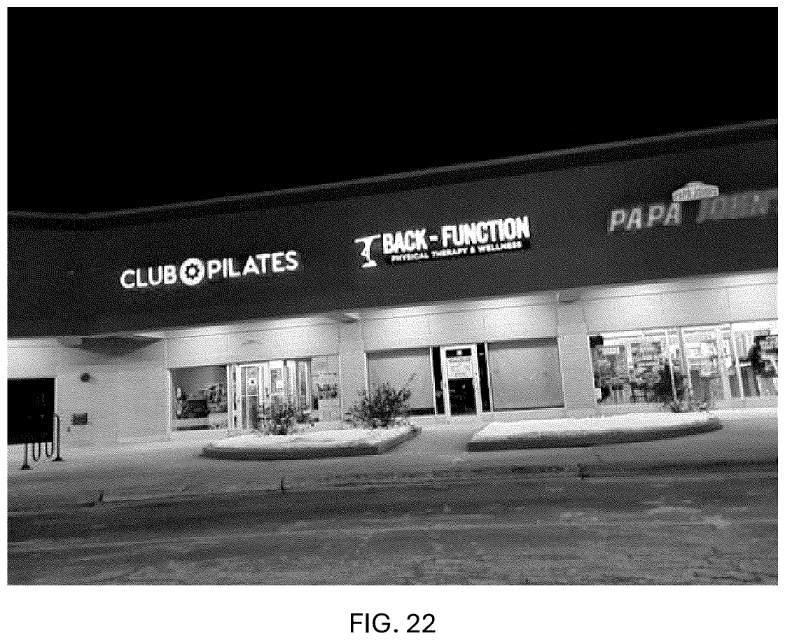

A non-limiting example of using system 100 and cane 200 is provided in FIGS. 22-25 and the accompanying description below. In accordance with step 104, image 2200 (shown in FIG. 22) is captured by pressing button 102. In accordance with step 108, control circuit 106 sends a signal to phone 110. Phone 110 then captures image 2200. In this example, image 2200 shows a group of stores. In step 112, phone 110 sends image 2200 to server 114. Image 2200 is then processed using process 400 (FIG. 4).

Image 2200 can be captured using software on mobile computing device 110 (for example a Smartphone app). For example, a smartphone can utilize an application program interface (Javascript Camera API and the Web Speech API) to access a camera on the mobile computing device 110.

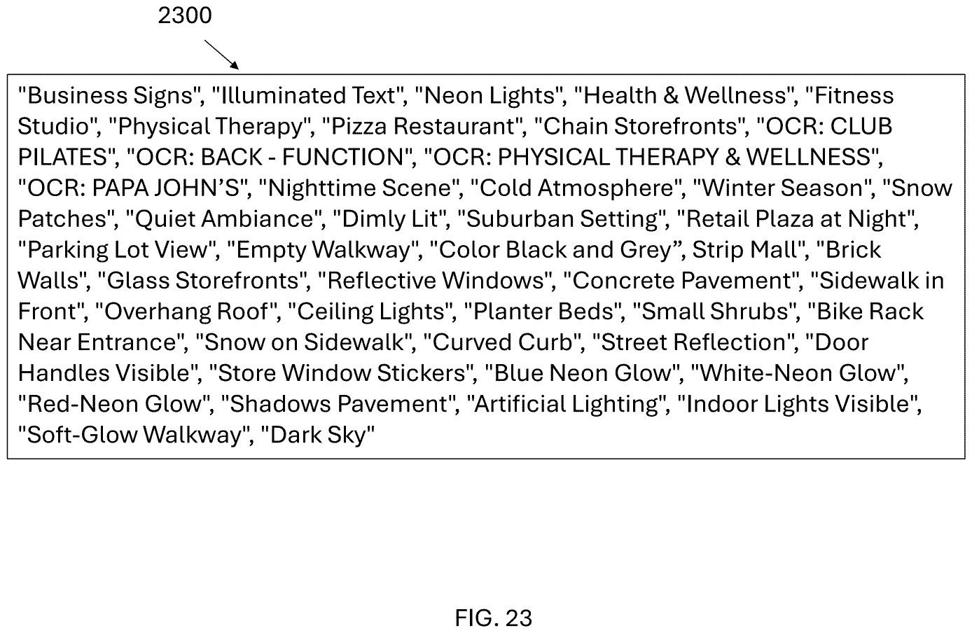

FIG. 23 depicts exemplary captions 2300 generated by first machine learning model 402 for exemplary image 2200. The captions 2300 contain data about the context of the image to inform the generated sentences. In particular, the captions describe objects in the image as well as other characteristics, like the mood, light, and other contextual details. In this example, first machine learning model 402 is implemented using a hyper-optimized open-source version of the Recognize Anything Model, or RAM (https://recognize-anything.github.io/). The filtering parameters of machine learning model 402 were optimized to generate more captions compared to the base RAM model. The number of captions 2300 is selected to provide sufficient information for further processing. In step 404, captions 2300 are then sent to second layer 406.

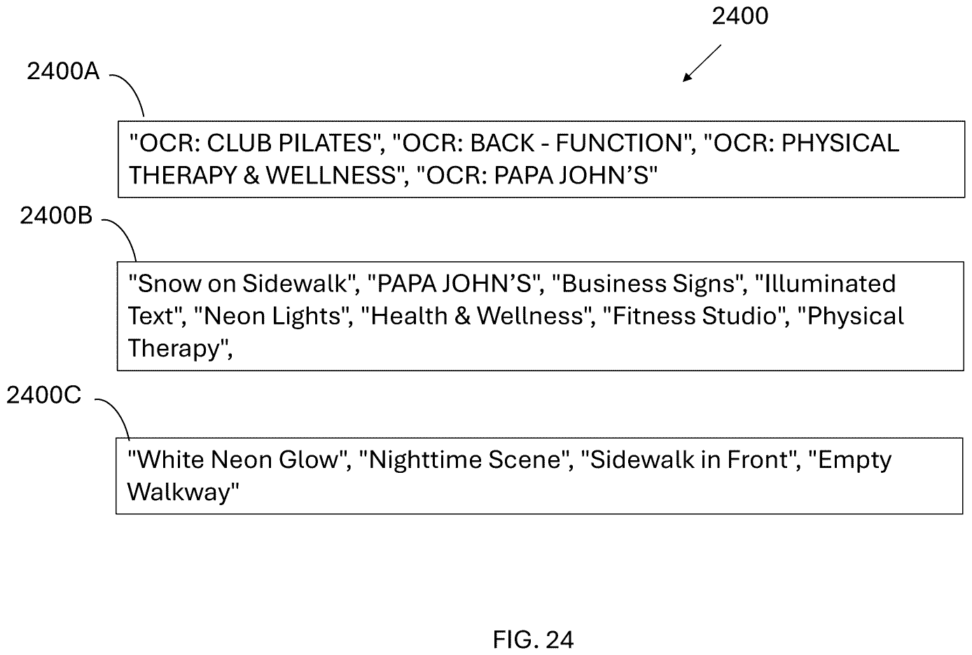

FIG. 24 depicts groupings of captions 2400A-C obtained by processing captions 1900 using the second machine learning model 406. The first group of captions 2400A depicts text captured in the image and describes the names of the stores displayed. The second group of captions 2400B shows groupings of what the service these businesses may provide. The third group of captions 2400C relates to the environment of the image including the surrounding street and walkway.

The second machine learning model 406 is trained to filter a subset of captions 2300 such that the remaining captions include features which are potentially important to a visually impaired individual, such as the name of the stores and details of the surrounding environment. In accordance with step 408, filtered captions 2400A-C are then sent to third machine learning model 410.

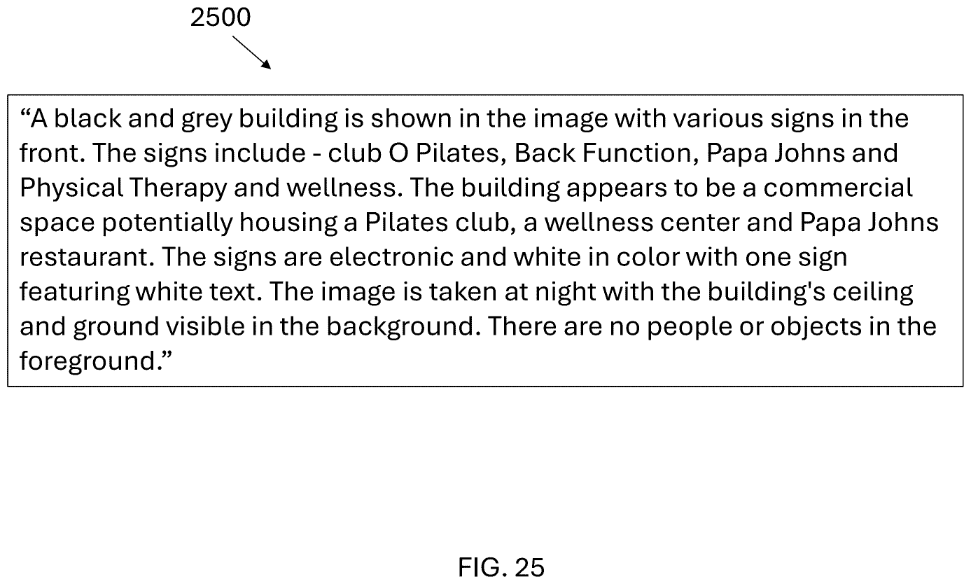

In the third machine learning model 410, sentences 2500 (see FIG. 25 and description below) are formed from the filtered captions. The third machine learning model 410 is a standard large language model from Astica (https://www.astica.org/gpt-s/). In addition, prompt 800 is sent to third machine learning model 410.

In accordance with step 116, sentences 2500 are then sent from server 114 to phone 110. FIG. 25 depicts sentences 2500 describing image 2200 produced by third neural network model 410 in response to prompt 800.

### Example 6

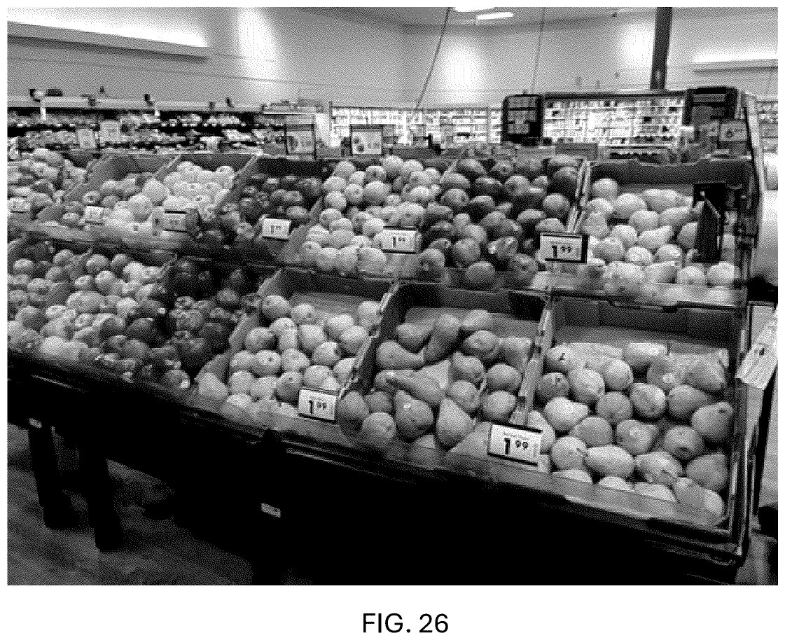

A non-limiting example of using system 100 and cane 200 is provided in FIGS. 26-29 and the accompanying description below. In accordance with step 104, image 2600 (shown in FIG. 26) is captured by pressing button 102. In accordance with step 108, control circuit 106 sends a signal to phone 110. Phone 110 then captures image 2600. In this example, image 2600 shows a fruit aisle in a grocery store. In step 112, phone 110 sends image 2600 to server 114. Image 2600 is then processed using process 400 (FIG. 4).

Image 2600 can be captured using software on mobile computing device 110 (for example a Smartphone app). For example, a smartphone can utilize an application program interface (Javascript Camera API and the Web Speech API) to access a camera on the mobile computing device 110.

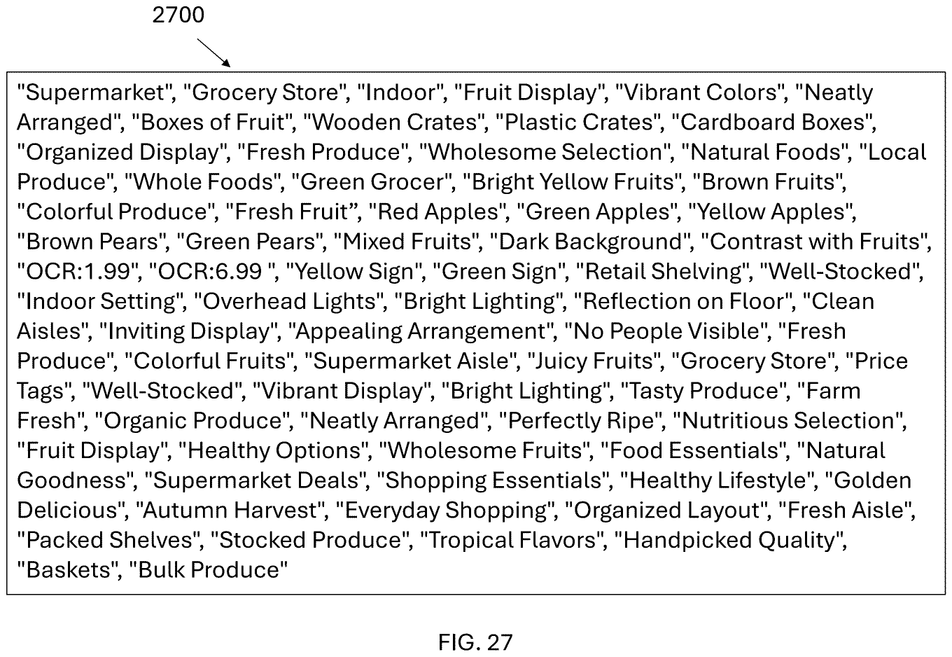

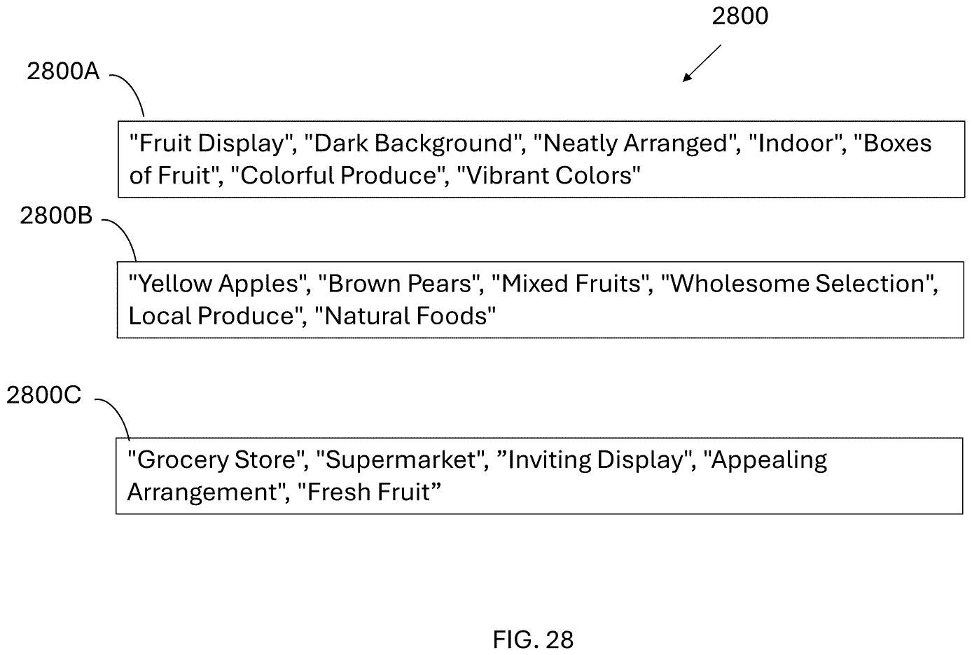

FIG. 27 depicts exemplary captions 2700 generated by first machine learning model 402 for exemplary image 2600. The captions 2700 contain data about the context of the image to inform the generated sentences. In particular, the captions describe objects in the image as well as other characteristics, like the mood, light, and other contextual details. In step 404, captions 2700 are then sent to second machine learning model 406. In this example, first machine learning model 402 is implemented using a hyper-optimized open-source version of the Recognize Anything Model, or RAM (https://recognize-anything.github.io/). The filtering parameters of machine learning model 402 were optimized to generate more captions compared to the base RAM model. The number of captions 2700 is selected to provide sufficient information for further processing. In step 404, captions 2700 are then sent to second layer 406. FIG. 28 depicts groupings of captions 2800A-C obtained by processing captions 2700 using the second machine learning model 406. The first group of captions 2800A broadly describes that fruit are displayed in the image. The second group of captions 2800B depicts what types of fruit are shown in the image. The third group of captions 2800C relates to the environment of the image including that describe the grocery store and the display itself.

The second machine learning model 406 is trained to filter a subset of captions 2700 such that the remaining captions include features which are potentially important to a visually impaired individual, such as identity of the fruit being sold and the relative location of each of the fruit. In accordance with step 408, filtered captions 2800A-C are then sent to third machine learning model 410.

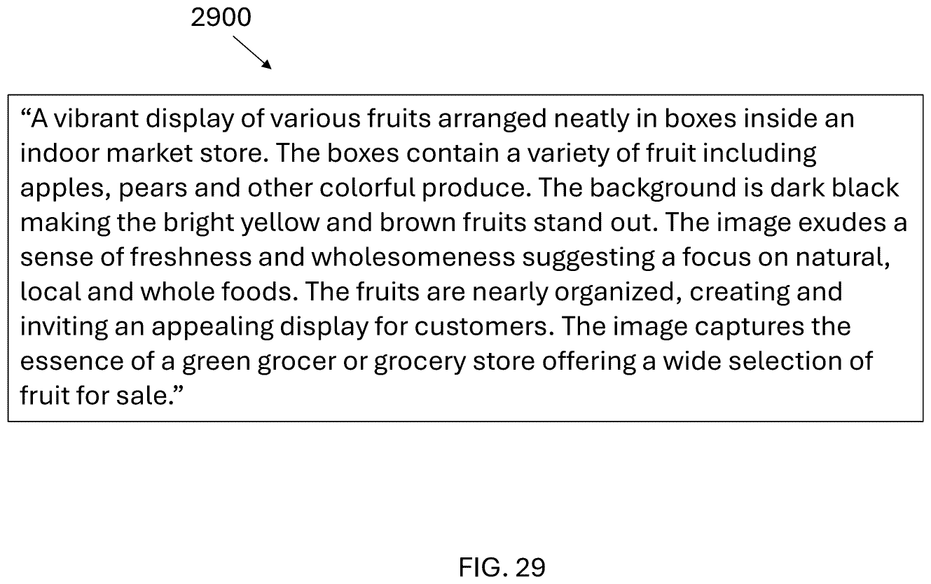

In the third neural machine learning model 410, sentences 2900 (see FIG. 29 and description below) are formed from the filtered captions. The third machine learning model 410 is a standard large language model from Astica (https://www.astica.org/gpt-s/). In addition, prompt 800 is sent to third machine learning model 410.

In accordance with step 116, sentences 2900 are then sent from server 114 to phone 110. FIG. 29 depicts sentences 2900 describing image 2600 produced by third neural network model 410 in response to prompt 800.

### Example 7

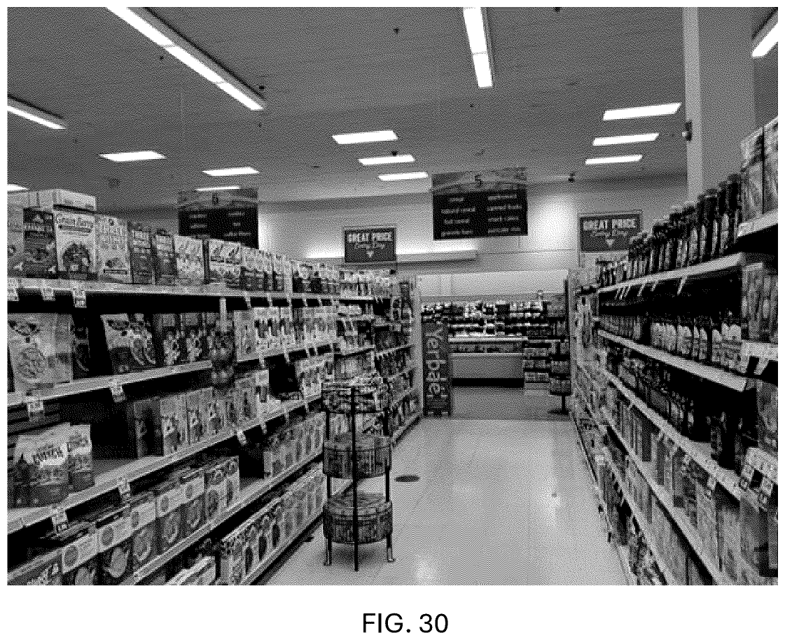

A non-limiting example of using system 100 and cane 200 is provided in FIGS. 30-33 and the accompanying description below. In accordance with step 104, image 3000 (shown in FIG. 30) is captured by pressing button 102. In accordance with step 108, control circuit 106 sends a signal to phone 110. Phone 110 then captures image 3000. In this example, image 3000 shows an aisle in a grocery store. In step 112, phone 110 sends image 3000 to server 114. Image 3000 is then processed using process 400 (FIG. 4).

Image 3000 can be captured using software on mobile computing device 110 (for example a Smartphone app). For example, a smartphone can utilize an application program interface (Javascript Camera API and the Web Speech API) to access a camera on the mobile computing device 110.

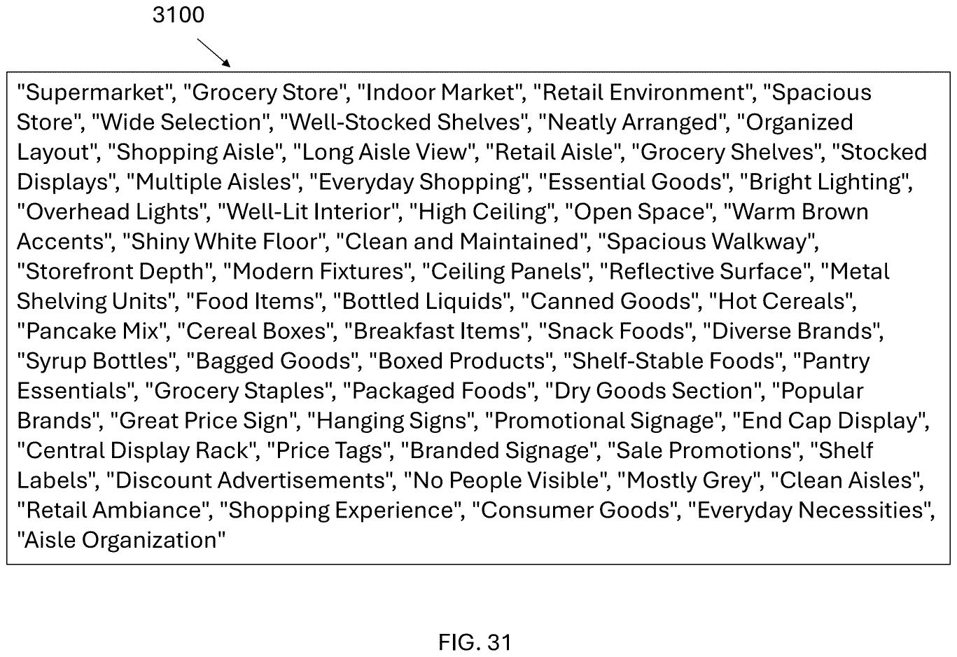

FIG. 31 depicts exemplary captions 3100 generated by first machine learning model 402 for exemplary image 3000. The captions 3100 contain data about the context of the image to inform the generated sentences. In particular, the captions describe objects in the image as well as other characteristics, like the mood, light, and other contextual details. In step 404, captions 3100 are then sent to second machine learning model 406. In this example, first machine learning model 402 is implemented using a hyper-optimized open-source version of the Recognize Anything Model, or RAM (https://recognize-anything.github.io/). The filtering parameters of machine learning model 402 were optimized to generate more captions compared to the base RAM model. The number of captions 3100 is selected to provide sufficient information for further processing. In step 404, captions 3100 are then sent to second layer 406.

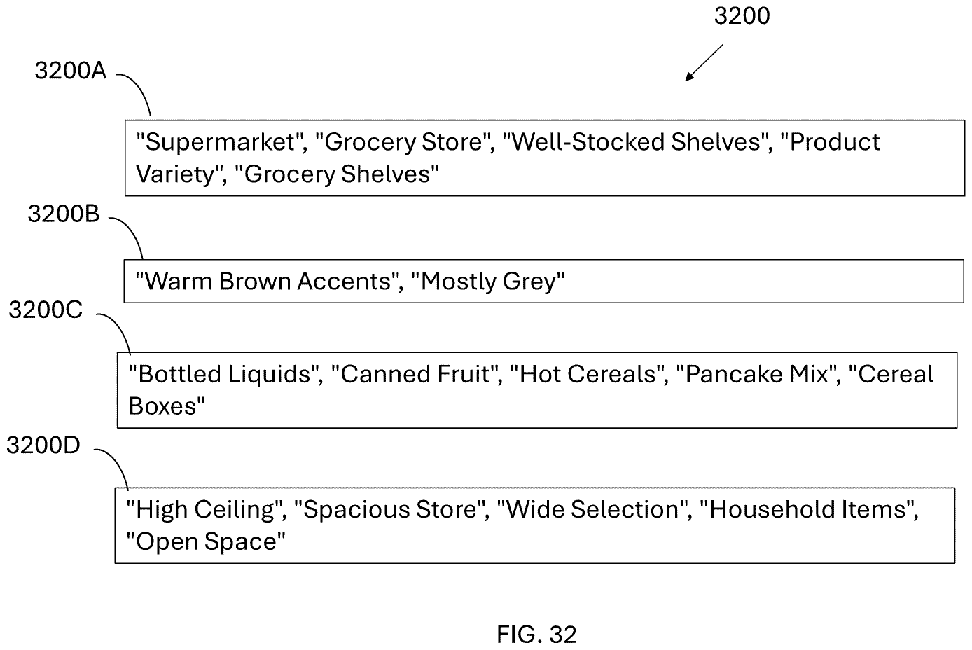

FIG. 32 depicts groupings of captions 3200A-D obtained by processing captions 3100 using the second machine learning model 406. The first group of captions 3200A describes that indicates that the image is of an aisle in a grocery store. The second group of captions 3200B describes the colors in the image. The third group of captions 3200C describes the products displayed in the image. The fourth group of captions 3200D describes the environment of the image and provides broad descriptions of what is captured in the image.

The second machine learning model 406 is trained to filter a subset of captions 3100 such that the remaining captions include features which are potentially important to a visually impaired individual, such as identity of each product in the aisle and the relative location of each of the products. In accordance with step 408, filtered captions 3200A-D are then sent to third machine learning model 410.

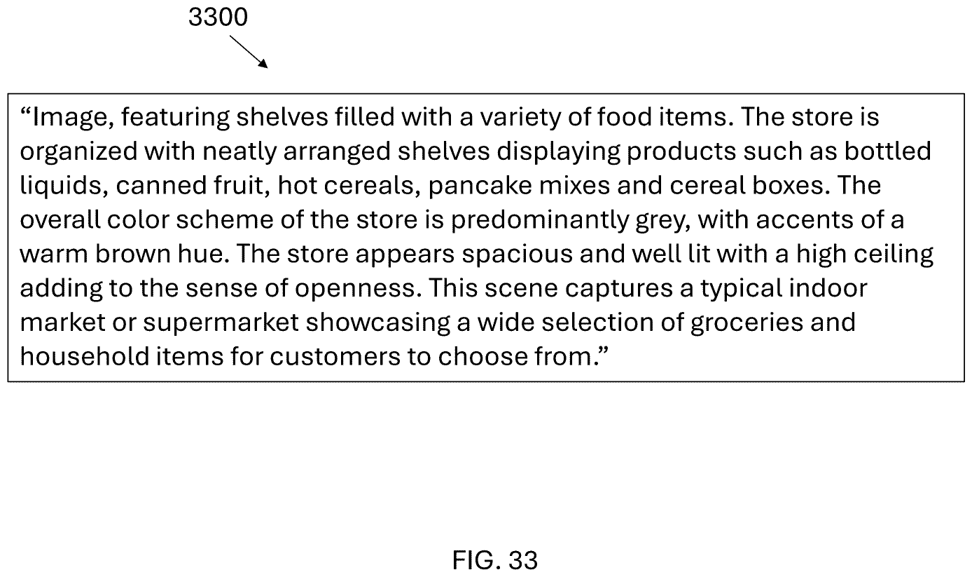

In the third machine learning model 410, sentences 3300 (see FIG. 33 and description below) are formed from the filtered captions. The third machine learning model 410 is a standard large language model from Astica (https://www.astica.org/gpt-s/). In addition, prompt 800 is sent to third machine learning model 410.

In accordance with step 116, sentences 3300 are then sent from server 114 to phone 110. FIG. 33 depicts sentences 3300 describing image 3000 produced by third neural network model 410 in response to prompt 800.

It is to be understood that the disclosed subject matter is not limited in its application to the details of construction and to the arrangements of the components set forth in the following description or illustrated in the drawings. The disclosed subject matter is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods, and systems for carrying out the several purposes of the disclosed subject matter. It is important, therefore, that the claims be regarded as including such equivalent constructions insofar as they do not depart from the spirit and scope of the disclosed subject matter.

Although the disclosed subject matter has been described and illustrated in the foregoing exemplary embodiments, it is understood that the present disclosure has been made only by way of example, and that numerous changes in the details of implementation of the disclosed subject matter may be made without departing from the spirit and scope of the disclosed subject matter, which is limited only by the claims which follow.

What is claimed is:

1. A system, comprising:
a cane configured to transmit an electromagnetic signal in response to a tactile input from a user;
a downloadable app embodied in a non-transitory computer-readable storage medium, the downloadable app comprising computer-readable program code, the computer-readable program code executable on a mobile computing device to perform operations comprising:
capturing a digital image in response to the electromagnetic signal;
transmitting the digital image via a wireless network to at least one server;
receiving a text description of the digital image via the wireless network from the at least one server; and
playing an audio version of the text description;
the at least one server configured to execute operations comprising:
generating a plurality of image captions for the digital image from a first machine learning model;
generating a data structure from a second machine learning model, the data structure comprising one or more subsets of image captions of the plurality of image captions; and
submitting a prompt comprising the data structure to a third machine learning model to obtain the text description of the digital image.

2. The system of claim 1, wherein the data structure comprises a ranking of a first image caption of the plurality of image captions relative to a second image caption of the plurality of image captions.

3. The system of claim 1, wherein the first machine learning model is a convolutional neural network.

4. The system of claim 1, wherein the second machine learning model is a large language model.

5. The system of claim 1, wherein the third deep learning model is a generative pretrained transformer with an attention mechanism.

6. The system of claim 1, wherein the plurality of image captions comprises between 50 and 200 image captions.

7. The system of claim 1, wherein a first subset of image captions of the one or more subsets of image captions comprises image captions that characterize a mood of the digital image.

8. The system of claim 1, wherein a first subset of image captions of the one or more subsets of image captions comprises image captions that characterize a spatial layout in the digital image.

9. The system of claim 1, wherein a first subset of image captions of the one or more subsets of image captions comprises image captions that characterize obstacles in the digital image.

10. The system of claim 1, wherein a first subset of image captions of the one or more subsets of image captions comprises image captions that characterize hazards in the digital image.

11. The system of claim 1, wherein a first subset of image captions of the one or more subsets of image captions comprises image captions that characterize a spatial layout in the digital image.

12. The system of claim 1, wherein a first subset of image captions of the one or more subsets of image captions comprises image captions that characterize text in the digital image.

13. The system of claim 1, wherein a first subset of image captions of the one or more subsets of image captions comprises image captions that characterize an advertisement in the digital image.

14. The system of claim 1, wherein the prompt comprises a request from the user.

15. The system of claim 14, wherein the operations executable on a mobile computing device further comprise:
recording an audio signal initiated by the user;
generating the request based on the recorded audio signal; and
transmitting the request to the at least one server.

16. The system of claim 1, wherein the prompt comprises a description of the one or more subsets of image captions.

17. The system of claim 1, wherein the second machine learning model removes a portion of the plurality of captions so that the portion is not present in the first subset of image captions and the portion is not present in the second subset of image captions.

18. The system of claim 17, wherein the prompt comprises an explanation that the removed portion was removed due to lack of relevance to the output of the third machine learning model.

19. The system of claim 1, wherein the cane is a white cane.

20. A method, comprising:
transmitting an electromagnetic signal from a cane in response to a tactile input from a user;
capturing a digital image in response to the electromagnetic signal;
transmitting the digital image via a wireless network;
obtaining a plurality of image captions for the digital image from a first machine learning model;
further obtaining a data structure from a second machine learning model, the data structure comprising a first subset of image captions of the plurality of image captions, and a second subset of image captions of the plurality of image captions;
forming a prompt comprising the data structure;
submitting the prompt to a third machine learning model to obtain the text description of the digital image;
receiving a text description of the digital image via the wireless network; and
playing an audio version of the text description.
